(19) United States
(12) Patent Application Publication
(10) Pub. No.: US 2013/0050365 A1
(43) Pub. Date: Feb. 28, 2013

(54) INK COMPOSITION, INK SET, AND IMAGE FORMING METHOD

(71) Applicant: Kiyoshi IRITA, Kanagawa (JP)

(72) Inventor: Kiyoshi IRITA, Kanagawa (JP)

(73) Assignee: FUJIFILM CORPORATION, Tokyo (JP)

(21) Appl. No.: 13/592,769

(22) Filed: Aug. 23, 2012

(30) Foreign Application Priority Data
Aug. 24, 2011 (JP) 2011-183094

(51) Int. Cl. C09D 11/10; B41J 2/01

(52) U.S. Cl. 347/100; 524/549; 524/548

(57) ABSTRACT

An ink composition capable of forming an image having a wide color reproduction range is provided.

The ink composition contains a pigment, the water-soluble polymerizable compound represented by general formula (1), an N-vinyl lactam compound, a polymerization initiator, and water. In the general formula (1), Q represents an n-valent linking group, and R¹ represents a hydrogen atom or a methyl group. Further, n represents an integer of 2 or more.

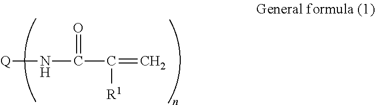

### BACKGROUND OF THE INVENTION

1. Field of the Invention

The present invention relates to an ink composition, an ink set, and an image forming method.

2. Description of the Related Art

Ink jet technology has been applied to image recording techniques for recording color images in the fields of office printers, home printers, and the like. Various studies have been made regarding image forming methods (ink jet recording methods) using ink jet technology and ink compositions used in these image forming methods.

For example, as ink compositions excellent in ejection stability, curability, adhesion to a substrate, and the like, ink compositions containing (A) a specific azo pigment, (B) N-vinyl lactams, (C) an ethylenically unsaturated compound capable of copolymerization with (B), (D) a polymeric dispersing agent, and (E) a radical polymerization initiator are known (for example, refer to JP2011-52140A).

In addition, as ink compositions excellent in curability with respect to the irradiation of active radiation, there are ink compositions containing (A) N-vinyl lactams, (B) esters and/or amides of (meth)acrylates having three or more ethylene oxide chains in the molecule, and (C) a polymerization initiator, in which ink compositions containing the (A) N-vinyl lactams at 10% by weight or more of the total weight of the ink composition are known (for example, refer to JP2007-262178A).

Further, as an ink jet recording method capable of performing high-speed and highly colorful printing, in ink jet recording methods having at least water, a polymerizable material undergoing radical polymerization according to light, a water-soluble photopolymerization initiator generating a radical according to the action of light, an ink containing a coloring material, and a reaction solution causing only the coloring material in the ink to aggregate, an ink jet recording method is known which irradiates UV (ultraviolet rays) on a recording material after the reaction solution and the coloring material have undergone an aggregation reaction, and improves the adhesion with the recording material (for example, refer to JP2010-274476A).

### SUMMARY OF THE INVENTION

However, when forming an image using aqueous curable-type ink including a pigment, a polymerizable compound, a polymerization initiator, and water, there are cases where the color reproduction range of the formed image is narrowed.

The present invention has been made in view of the above, and an object thereof is to provide an ink composition, ink set, and image forming method capable of forming images with a wide color reproduction range.

An ink composition of the present invention for solving the problem contains a pigment, a water-soluble polymerizable compound represented by general formula (1), an N-vinyl lactam compound, a polymerization initiator, and water.

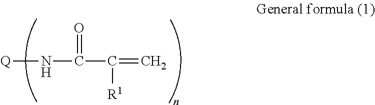

[In the general formula (1), Q represents an n-valent linking group, and R¹ represents a hydrogen atom or a methyl group. Further, n represents an integer of 2 or more.]

Preferably, the N-vinyl lactam compound is a monofunctional N-vinyl lactam compound.

Also preferably, the N-vinyl lactam compound is a compound represented by the following general formula (A).

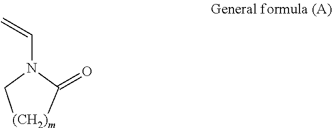

[In the general formula (A), m represents an integer of 1 to 5.]

Also preferably, Q in the general formula (1) is a linking group including an oxyalkylene group.

Also preferably, the N-vinyl lactam compound is at least any one of N-vinyl pyrrolidone and N-vinyl-ε-caprolactam.

Also preferably, the water content with respect to the total amount of the ink composition is 50% by mass or more.

Also, preferably, n in the general formula (1) is an integer of 3 or more

The ink set of the present invention includes the ink composition of the present invention, and a processing liquid including a flocculant causing the components in the ink composition to aggregate.

The image forming method of the present invention uses the ink set of the present invention and includes: a processing liquid adding step of adding the processing liquid onto a recording medium, an ink adding step of adding the ink composition onto the processing liquid added onto the recording medium, and an active energy ray irradiating step of irradiating active energy rays to the ink composition added onto the recording medium.

In addition, the image forming method of the present invention uses an ink set including a first ink composition of the present invention; a second ink composition containing a pigment, a polymerizable compound, a polymerization initiator, and water; and a processing liquid including a flocculant causing at least the components in the first ink composition to aggregate, and includes a processing liquid adding step of adding the processing liquid onto a recording medium, a first ink adding step of adding the first ink composition onto the processing liquid added onto the recording medium, a step of adding the second ink composition onto the added first ink composition, and a step of irradiating active energy rays to the ink composition of a plurality of colors including the first ink composition and the second ink composition.

Also, preferably, the flocculant further causes the components in the second ink composition to aggregate.

Also, preferably, the recording medium is coated paper having a base sheet and a coating layer including an inorganic pigment.

According to the present invention, it is possible to provide an ink composition, ink set, and image forming method capable of forming images with a wide color reproduction range.

### BRIEF DESCRIPTION OF THE DRAWINGS

FIG. 1 is a schematic configurational diagram showing an example of an ink jet recording apparatus suitable for the image forming method of the present invention.

### DESCRIPTION OF THE PREFERRED EMBODIMENTS

<<Ink Composition>>

The ink composition (below, simply referred to as “ink”) of the present invention contains a pigment, a water-soluble polymerizable compound represented by general formula (1) described below, an N-vinyl lactam compound, a polymerization initiator, and water.

According to studies of the present inventors, when forming an image using an aqueous curable-type ink composition (aqueous curable-type ink) of the related art including a pigment, a polymerizable compound, a polymerization initiator, and water, it was clear that there are cases where the color reproduction range of the formed image is reduced. For example, this trend is particularly remarkable when forming an image of multiple colors (for example, 2 to 4 colors) in which inks of two colors or more are superimposed.

Thus, by setting the aqueous curable-type ink to the configuration of above-described present invention, that is, by including a water-soluble polymerizable compound represented by the general formula (1) described below and an N-vinyl lactam compound in the aqueous curable-type ink, it is possible to suppress a phenomenon in which the color reproduction range of the image is reduced, which is a phenomenon specific to the aqueous curable-type ink. Here, when at least one of the water-soluble polymerizable compound represented by general formula (1) and the N-vinyl lactam compound is lacking, the phenomenon cannot be suppressed, and the color reproduction range is reduced.

In addition, according to the ink composition of the present invention, in addition to expanding the color reproduction range of the image, the glossiness of the image is also improved.

<Water-Soluble Polymerizable Compound Represented by General Formula (1)>

The ink composition of the present invention contains a water-soluble polymerizable compound represented by general formula (1) described below (below, referred to as “polymerizable compound represented by general formula (1)”).

By containing both of the polymerizable compound represented by the general formula (1) and an N-vinyl lactam compound described below, the ink composition of the present invention expands the color reproduction range of the image.

Here, “water soluble” means dissolvable in water at a fixed concentration or more, and it is sufficient to be (preferably uniformly) dissolvable in the aqueous ink. In addition, it is sufficient to be (preferably uniformly) dissolved in the ink after increasing the solubility by adding the water-soluble solvent described below. Specifically, it is preferable that the solubility with respect to water at 25° C. be 10% by mass or more and more preferable that it be 15% by mass or more.

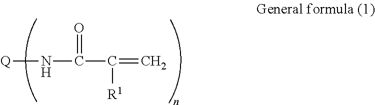

In the general formula (1), Q represents an n-valent linking group, and R¹ represents a hydrogen atom or a methyl group. Further, n represents an integer of 2 or more.

The compound represented by the general formula (1) is a polyfunctional acrylamide in which an unsaturated vinyl monomer is bonded to the linking group Q by an amide bond.

R¹ represents a hydrogen atom or a methyl group, and is preferably a hydrogen atom.

In addition, n is preferably an integer of 3 or more from the viewpoint of further expanding the color reproduction range of the image. The upper limit of n is not particularly limited; however, the upper limit is preferably 6, and more preferably 4.

In addition, the linking group Q is not particularly limited as long as it is a group capable of linking with an acrylamide structure; however, the compound represented by general formula (1) is preferably selected from linking groups exhibiting the water solubility mentioned above, specifically, the residue in which one or more hydrogen atoms or hydroxyl groups are removed from the following compound group X may be exemplified.

—Compound Group X—

Ethylene glycol, diethylene glycol, triethylene glycol, polyethylene glycol, propylene glycol, dipropylene glycol, tripropylene glycol, polypropylene glycol, 1,3-propanediol, 1,2-butanediol, 1,3-butanediol, 1,4-butanediol, 2,3-butanediol, 1,5-pentanediol, 1,4-pentanediol, 2,4-pentanediol, 3-methyl-1,5-pentanediol, 2-methyl-2,4-pentanediol, 1,5-hexanediol, 1,6-hexanediol, 2,5-hexanediol, glycerin, 1,2,4-butanetriol, 1,2,6-hexanetriol, 1,2,5-pentanetriol, thioglycol, trimethylolpropane, ditrimethylolpropane, trimethylolethane, ditrimethylolethane, neopentyl glycol, pentaerythritol, dipentaerythritol, and condensates thereof, polyols such as low-molecular-weight polyvinyl alcohols or sugars, and polyamines such as ethylenediamine, diethylenetriamine, triethylenetetramine, polyethyleneimine, and polypropylene diamine.

In addition, substituted or unsubstituted alkylene chains having four or less carbon atoms such as methylene, ethylene, propylene, and butylene groups; furthermore, functional groups or the like having saturated or unsaturated hetero rings such as a pyridine ring, an imidazole ring, a pyrazine ring, a piperidine ring, a piperazine ring, and a morpholine ring, can be exemplified.

Even among these, the linking group Q is preferably a linking group including an oxyalkylene group (preferably an oxyethylene group). Even among these, a linking group including two or more oxyalkylene groups (preferably oxyethylene groups) is more preferable, and a linking group including three or more oxyalkylene groups (preferably oxyethylene groups) is even more preferable.

A particularly preferable form of the linking group Q is one in which the linking group Q is a polyol residue including (preferably two or more, more preferably three or more) oxyalkylene groups (preferably oxyethylene groups).

Further, the polymerizable compound represented by the above-described general formula (1) preferably has an SP value of 9 to 11.5 (cal/cm³)^{0.5}, more preferably has an SP value of 9 to 10.5 (cal/cm³)^{0.5}, and even more preferably has an SP value of 9 to 10 (cal/cm³)^{0.5}. By setting the SP value to the above-mentioned specific ranges, it is possible to more effectively obtain the relevant effects.

Here, description will be given of the SP value in the present invention.

The SP value uses the Hansen solubility parameters. Hansen solubility parameters divide the solubility parameters introduced by Hildebrand into three components of a dispersion element δd, a polarity element δp, and a hydrogen bond element δh, and provide a three-dimensional representation thereof; however, in the present invention, the SP value is represented by δ[(cal/cm³)^{0.5}] and a value calculated using the following formula is used.

δ[(cal/cm³)^{0.5}]=(δd²+δp²+δh²)^{0.5}

Here, the dispersion element δd, the polarity element δp, and the hydrogen bond element δh were determined to a large extent by Hansen and those who continued his research and are listed in detail in the Polymer Handbook (fourth edition) VII-698 to 711.

Further, the values of the Hansen solubility parameters for a large number of solvents and resins have been investigated, for example, as described in the Industrial Solvents Handbook by Wesley L. Archer.

Specific examples of the polymerizable compound represented by the general formula (1) are shown below. However, the present invention is not limited to the following specific examples.

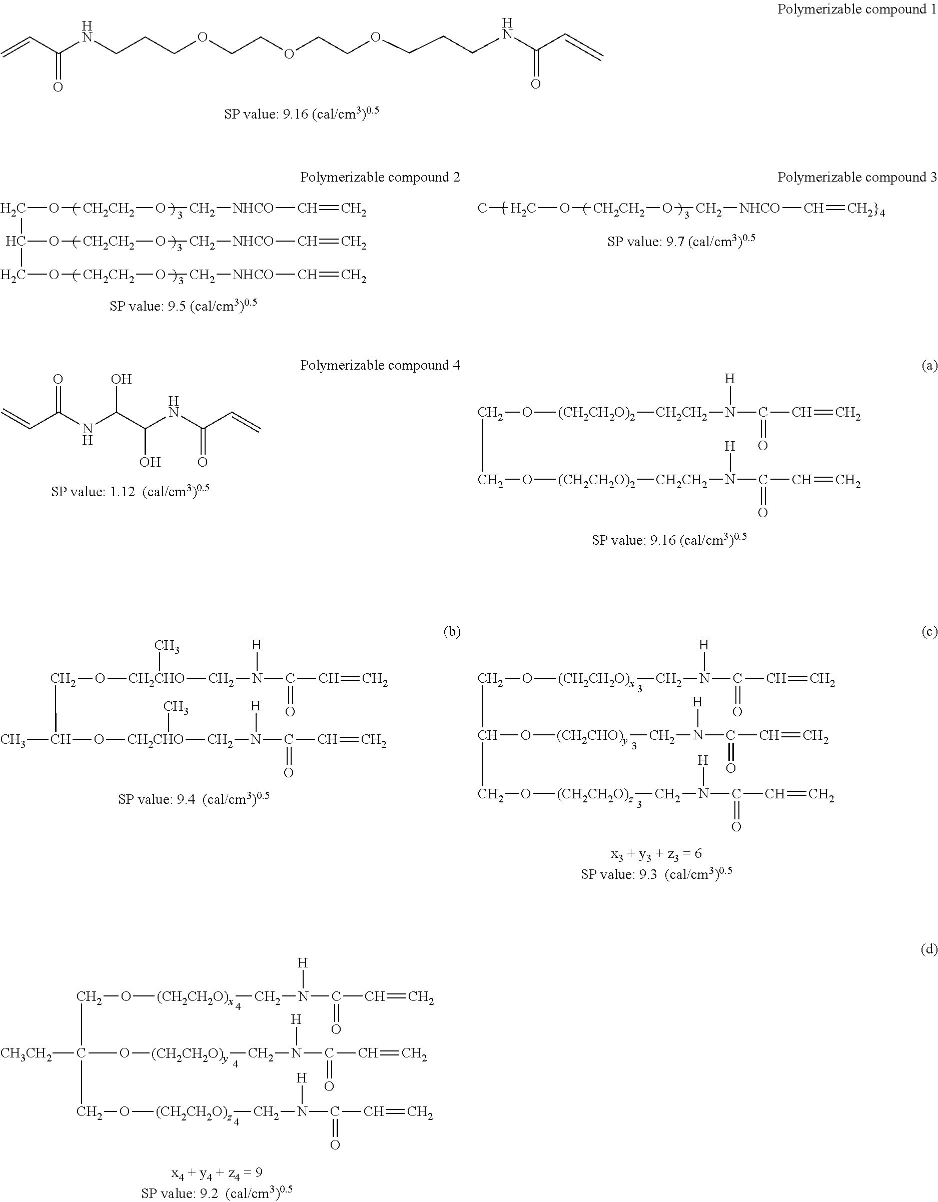

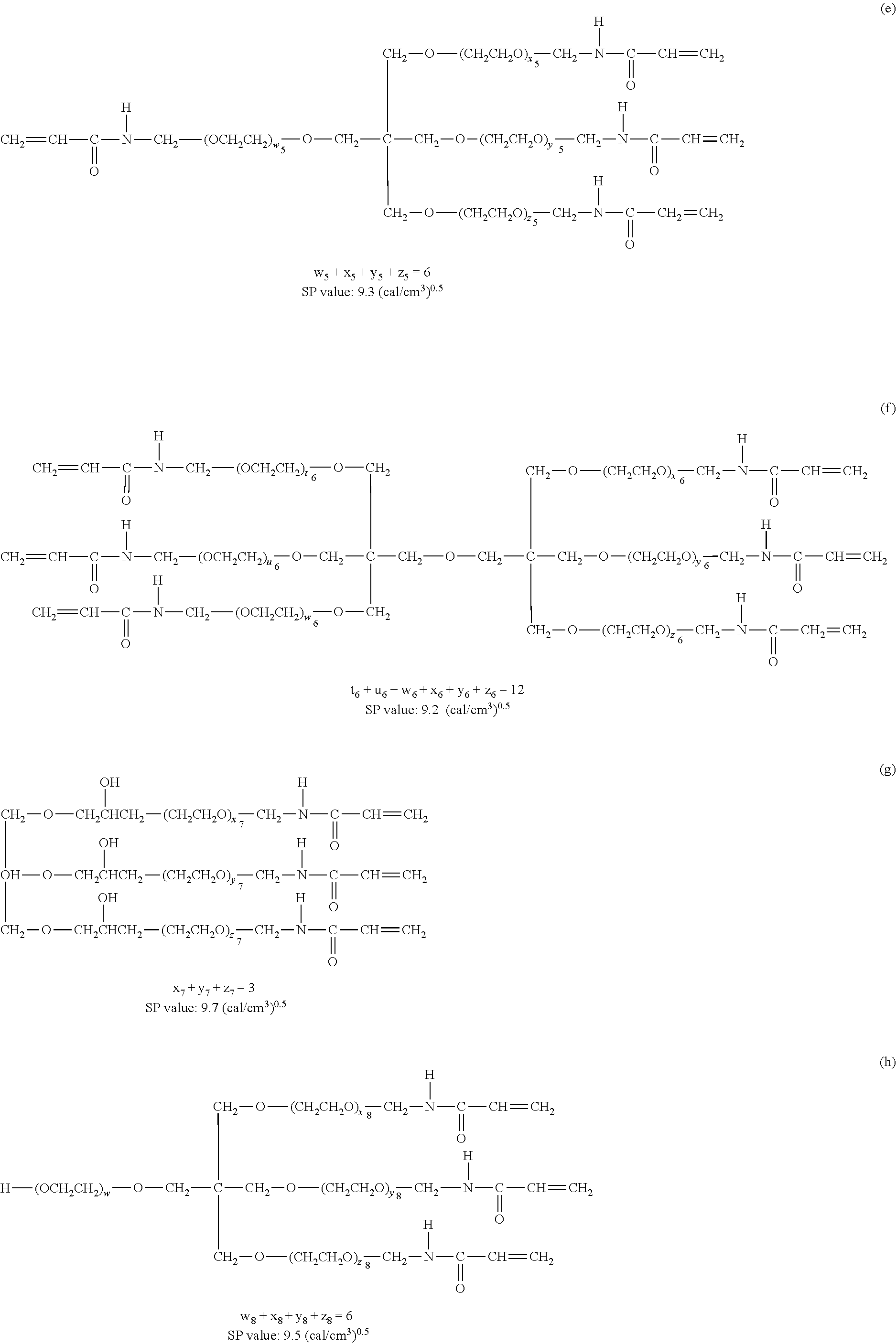

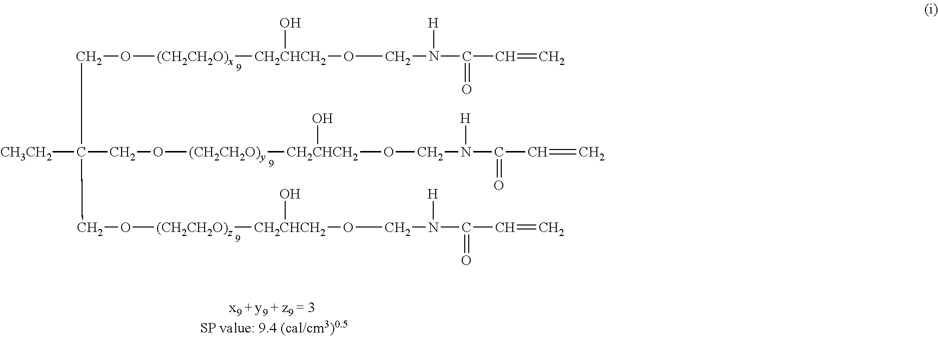

The polymerizable compound represented by the general formula (1) can be used alone or in combination of two or more kinds.

The content of the polymerizable compound represented by the general formula (1) in the ink composition of the present invention (in the case of two or more kinds, the total content, to which the following applies in the same manner) is not particularly limited; however, from the viewpoint of further expanding the color reproduction range of the image, the content is preferably 2 to 30% by mass, more preferably 5 to 20% by mass, and particularly preferably 5 to 15% by mass, with respect to the total mass of the ink composition.

<N-Vinyl Lactam Compound>

The ink composition of the present invention includes an N-vinyl lactam compound.

In the ink composition of the present invention, the N-vinyl lactam compound functions as a polymerizable compound. In the present invention, by including both the N-vinyl lactam compound and the polymerizable compound represented by the general formula (1), the color reproduction range of the image is expanded.

The N-vinyl lactam compound is not particularly limited; however, a monofunctional N-vinyl lactam compound (that is, an N-vinyl lactam compound having one ethylenic double bond) is preferable.

As a preferable example of the N-vinyl lactam compound, the compound represented by general formula (A) may be exemplified.

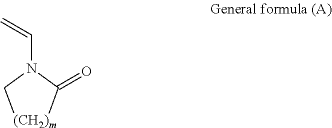

In the general formula (A), m represents an integer of 1 to 5.

From the viewpoints of the flexibility of the ink composition after curing, the adhesion to the target recording medium, and the availability of raw materials, it is preferable that the m be an integer of 2 to 4, and more preferable that the m be 2 or 4.

That is, as the compound represented by the general formula (A), at least any one of N-vinyl pyrrolidone and N-vinyl caprolactam is particularly preferable.

Among these, N-vinyl caprolactam is excellent in terms of safety, is available generically at comparatively low cost, and is preferable since it can obtain particularly favorable image curing as well as adhesion to the target recording medium of the cured film.

Further, the N-vinyl lactam compound may have a substituent such as an alkyl group, or aryl group on the lactam ring, and may link a saturated or unsaturated ring structure.

The N-vinyl lactam compound may be contained as only one kind in the ink composition, or may be contained as a plurality of kinds.

The content of the N-vinyl lactam compound in the ink composition of the present invention (in the case of two or more kinds, the total content, to which the following applies in the same manner) is not particularly limited; however, from the viewpoint of further expanding the color reproduction range of the image, the content is preferably 1 to 20% by mass, more preferably 2 to 15% by mass, and particularly preferably 2 to 10% by mass, with respect to the total mass of the ink composition.

In addition, in the above-described ranges, it is possible to obtain an ink composition exhibiting more favorable copolymerization with other polymerizable compounds (for example, the polymerizable compound represented by the general formula (1)) and having superior curability. In addition, the N-vinyl lactam compound is a compound having a relatively high melting point. An ink composition in which the content of the N-vinyl lactam compound is 20% by mass or less with respect to the total mass of the ink composition exhibits favorable solubility even at low temperatures of 0° C. or less and the temperature range in which the ink composition can be handled is wider, which is preferable.

Further, in the ink composition of the present invention, the ratio of the total mass of the N-vinyl lactam compound with respect to the total of the total mass of the N-vinyl lactam compound and the total mass of the polymerizable compound represented by the general formula (1) [total mass of the N-vinyl lactam compound/(total mass of the N-vinyl lactam compound+total mass of the polymerizable compound represented by the general formula (1))] is not particularly limited; however, from the viewpoint of expanding the color reproduction range, the ratio is preferably 0.05 to 0.90, more preferably 0.05 to 0.85, and particularly preferably 0.10 to 0.70.

<Pigments>

The ink composition of the present invention contains a pigment.

The pigment is not particularly limited and can be appropriately selected depending on the purpose, for example, the pigment may be any of an organic pigment or an inorganic pigment. That the pigment is insoluble or almost insoluble in water is preferable from the viewpoint of the ink colorability.

As organic pigments, for example, azo pigments, polycyclic pigments, chelate dyes, nitro pigments, nitroso pigments, aniline black, and the like may be exemplified. Among these, azo pigments, polycyclic pigments, and the like are more preferable.

In addition, as inorganic pigments, for example, titanium oxide, iron oxide, calcium carbonate, barium sulfate, aluminum hydroxide, barium yellow, cadmium red, chrome yellow, carbon black, and the like, may be exemplified. Even among these, carbon black is particularly preferable.

Regarding the pigments, as a pigment for orange or yellow, for example, C. I. pigment orange 31, C. I. pigment orange 43; C. I. pigment yellow 12, C. I. pigment yellow 13, C. I. pigment yellow 14, C. I. pigment yellow 15, C. I. pigment yellow 17, C. I. pigment yellow 74, C. I. pigment yellow 93, C. I. pigment yellow 94, C. I. pigment yellow 128, C. I. pigment yellow 138, C. I. pigment yellow 151, C. I. pigment yellow 155, C. I. pigment yellow 180, C. I. pigment yellow 185, and the like, may be exemplified.

Regarding the pigments, as a pigment for magenta or red, for example, C. I. pigment red 2, C. I. pigment red 3, C. I. pigment red 5, C. I. pigment red 6, C. I. pigment red 7, C. I. pigment red 15, C. I. pigment red 16, C. I. pigment red 48:1, C. I. pigment red 53:1, C. I. pigment red 57:1, C. I. pigment red 122, C. I. pigment red 123, C. I. pigment red 139, C. I. pigment red 144, C. I. pigment red 149, C. I. pigment red 166, C. I. pigment red 177, C. I. pigment red 178, C. I. pigment red 222; C. I. pigment violet 19, and the like, may be exemplified.

Regarding the pigments, as a pigment for green or cyan, for example, C. I. pigment blue 15, C. I. pigment blue 15:2, C. I. pigment blue 15:3, C. I. pigment blue 15:4, C. I. pigment blue 16, C. I. pigment blue 60; C. I. pigment green 7, and siloxane-crosslinked aluminum phthalocyanine as described in U.S. Pat. No. 4,311,775A and the like, may be exemplified.

Regarding the pigments, as a pigment for black, for example, C. I. pigment black 1, C. I. pigment black 6, C. I. pigment black 7, and the like, may be exemplified.

In addition, as the azo pigments, it is possible to use azo pigments represented by formula (1) disclosed in paragraphs 0015 to 0069 of JP2011-52140A.

In addition, the average particle diameter of the pigment is preferably smaller from the viewpoint of transparency and color reproducibility; however, preferably larger from the viewpoint of light resistance. Considering both of these, the average particle diameter is preferably 10 to 200 nm, more preferably 10 to 150 nm, and even more preferably 10 to 120 nm. Further, there is no particular limitation relating to the particle size distribution of the pigment, and any one having a wide particle size distribution or having a monodispersed particle size distribution is sufficient. Further, two or more kinds of pigments having a monodispersed particle size distribution may be mixed and used.

In the ink composition of the present invention, the pigment may be used alone or in a combination of two or more kinds.

The content of the pigment (in the case of two or more kinds, the total content) is preferably 1 to 25% by mass, more preferably 1 to 20% by mass, and particularly preferably 1 to 15% by mass, with respect to the total mass of the ink composition.

(Dispersing Agent)

The ink composition of the present invention can contain at least one kind of dispersing agent.

The dispersing agent may be any of a polymeric dispersing agent or a low-molecular-weight surfactant-type dispersing agent. In addition, the polymeric dispersing agent may be either a water-soluble dispersing agent or a water-insoluble dispersing agent.

As the low-molecular-weight surfactant-type dispersing agent, for example, it is possible to use the low-molecular-weight surfactant-type dispersing agent disclosed in paragraphs 0016 to 0020 of JP2010-188661A.

As the water-soluble dispersing agent in the polymeric dispersing agents, a hydrophilic polymer compound may be exemplified. For example, as natural hydrophilic polymer compounds, plant polymers such as gum arabic, gum tragacanth, guar gum, karaya gum, locust bean gum, arabinogalactan, pectin, and quince seed starch; seaweed based polymers such as alginate, carrageenan, and agar; animal-based polymers such as gelatin, casein, albumin, collagen, and shellac; microbial polymers such as xanthan gum and dextran, and the like, may be exemplified.

Further, for hydrophilic polymer compounds modifying natural products into raw materials, cellulose-based polymers such as methyl cellulose, ethyl cellulose, hydroxyethyl cellulose, hydroxypropyl cellulose, and carboxymethyl cellulose; starch-based polymers such as sodium starch glycolate and sodium starch phosphate ester; seaweed-based polymers such as sodium alginate and propylene glycol alginate, and the like, may be exemplified.

In addition, as synthetic hydrophilic polymer compounds, vinyl polymers such as polyvinyl alcohol, polyvinyl pyrrolidone, and polyvinyl methyl ether; non-crosslinked polyacrylamide, polyacrylic acid or an alkali metal salt thereof; acrylic-based resins such as water-soluble styrene acrylic resin; water-soluble styrene maleic acid resin; water-soluble vinyl naphthalene acrylic resin; water-soluble vinyl naphthalene maleic acid resin; polyvinylpyrrolidone; polyvinyl alcohol; alkali metal salts of β-naphthalene sulfonic acid formalin condensate; polymer compounds having a salt of a cationic functional group such as quaternary ammonium or an amino group in a side chain, and the like, may be exemplified.

Even among these, a water-soluble dispersing agent into which a carboxyl group has been introduced, such as a copolymer with an acrylic acid, a methacrylic acid, and a hydrophilic monomers having carboxyl groups, is preferable as the hydrophilic polymer compound.

As the water-insoluble dispersing agents in the polymeric dispersing agents, it is possible to use a polymer having both a hydrophobic part and a hydrophilic part. For example, styrene-(meth)acrylic acid copolymers, styrene-(meth)acrylic acid-(meth)acrylic acid ester copolymers, (meth)acrylic acid ester-(meth)acrylic acid copolymers, polyethylene glycol (meth)acrylate-(meth)acrylic acid copolymers, vinyl acetate-maleic acid copolymers, styrene-maleic acid copolymers, and the like, may be exemplified.

The weight average molecular weight of the polymeric dispersing agent is preferably 3,000 to 100,000, more preferably 5,000 to 50,000, even more preferably 5,000 to 40,000, and particularly preferably 10,000 to 40,000.

From the viewpoints of self-dispersibility and aggregation speed when contacting the processing liquid, the polymeric dispersing agent is preferably a polymer having a carboxyl group, more preferably a polymer having a carboxyl group and an acid value of 100 mg KOH/g or less, and even more preferably a polymer having a carboxyl group and an acid value of 25 to 100 mg KOH/g. In particular, in a case where the ink composition of the present invention is used in combination with a processing liquid (the details are described below) causing the components in the ink composition to aggregate, a polymeric dispersing agent having a carboxyl group and an acid value of 25 to 100 mg KOH/g is effective.

As the mixing mass ratio (p:s) of the pigment (p) and the dispersing agent (s), a range of 1:0.06 to 1:3 is preferable, a range of 1:0.125 to 1:2 is more preferable, and even more preferable is 1:0.125 to 1:1.5.

In a case of using dyes instead of pigments in the present invention, it is possible to use one holding a dye in a water-insoluble carrier. As the dyes, it is possible to use any known dyes without any particular limitation, for example, the dyes disclosed in JP2001-115066A, JP2001-335714A, JP2002-249677A, and the like can also be suitably used in the present invention. In addition, the carrier is not particularly limited as long as it is almost insoluble in water or insoluble in water, and inorganic materials, organic materials and composites thereof can be used. Specifically, the carriers disclosed in JP2001-181549A, JP2007-169418A, and the like can also be suitably used in the present invention.

The carrier (water-insoluble colored particles) that holds the dye can be used as an aqueous dispersoid using a dispersing agent. As the dispersing agent, the above-described dispersing agents can be suitably used.

In the present invention, from the viewpoints of light resistance and quality of the image, it is preferable to include a pigment and a dispersing agent, more preferable to include an organic pigment and a polymeric dispersing agent, and particularly preferable to include an organic pigment and a polymeric dispersing agent having a carboxyl group. In addition, from the viewpoint of aggregability, it is preferable that the pigment be coated with a polymeric dispersing agent having a carboxyl group and be water-insoluble.

As the average particle diameter of the pigment in a dispersed state, 10 to 200 nm is preferable, 10 to 150 nm is more preferable, and 10 to 100 nm is even more preferable. When the average particle diameter is 200 nm or less, the color reproduction becomes favorable, the ejection characteristics during ejecting in the ink jet recording method become favorable, and, when 10 nm or more, the light resistance becomes favorable. In addition, the particle size distribution of the coloring material is not particularly limited, and may be either of a wide particle size distribution or a particle size distribution with a monodispersed property. Further, it is also possible to use a mixture of two or more kinds of coloring material having a particle size distribution with a monodispersed property.

Here, the average particle diameter of the pigment in the dispersed state shows the average particle diameter in the state made into an ink; however, the same applies for the so-called concentrated ink dispersoid of the stage before being made into an ink.

Here, the average particle diameter of the pigment in the dispersed state, and the average particle diameter and particle size distribution of the polymer particles are determined by measuring the volume average particle diameter according to a dynamic light scattering method using the Nanotrac particle size distribution measurement apparatus UPA-EX150 (manufactured by Nikkiso, Co., Ltd.).

<Polymerization Initiator>

The ink composition of the present invention contains a polymerization initiator.

The polymerization initiator can be used alone as a single kind, or two or more kinds can be mixed, or can be used in combination with a sensitizer.

The polymerization initiator can contain an appropriately selected compound capable of starting a polymerization reaction using active energy rays, for example, it is possible to use a polymerization initiator generating an active species (radicals, acids, bases, and the like) using radiation, light, or electron beams. Among these, a radical polymerization initiator generating a radical using radiation, light, or electron beams is preferable.

As the polymerization initiator, for example, acetophenone, 2,2-diethoxyacetophenone, p-dimethylaminoacetophenone, p-dimethylaminopropiophenone, benzophenone, 2-chlorobenzophenone, p,p′-dichlorobenzophenone, p,p′-bis-diethylaminobenzophenone, Michler's ketone, benzil, benzoin, benzoin methyl ether, benzoin ethyl ether, benzoin isopropyl ether, benzoin n-propyl ether, benzoin isobutyl ether, benzoin n-butyl ether, benzyl dimethyl ketal, tetramethylthiuram monosulfide, thioxanthone, 2-chloro thioxanthone, 2-methyl thioxanthone, azobisisobutyronitrile, benzoin peroxide, di-tert-butyl peroxide, 1-hydroxycyclohexyl phenyl ketone, 1-[4-(2-hydroxyethoxy)-phenyl]-2-hydroxy-2-methyl-1-propan-1-one, 2-hydroxy-2-methyl-1-phenyl-1-one, 1-(4-isopropylphenyl)-2-hydroxy-2-methylpropan-1-one, and methylbenzoyl formate may be exemplified. In addition, for example, aromatic diazonium salts, aromatic halonium salts, aromatic sulfonium salts, metallocene compounds, and the like such as triphenylsulfonium hexafluorophosphate and diphenyliodonium hexafluoroantimonate, and the like may be exemplified.

The polymerization initiator is preferably water-soluble. Here, water-soluble with regard to the polymerization initiator signifies 0.5% by mass or more dissolving in distilled water at 25° C. It is preferable that 1% by mass or more of the water-soluble polymerization initiator dissolve in distilled water at 25° C. and more preferable that 3% by mass or more dissolve.

As the water-soluble polymerization initiator, for example, the compound represented by the following general formula (B), or the compounds and the like disclosed in JP2005-307198A can be exemplified. Among these, from the viewpoints of adhesion and scratch resistance, the compound represented by the following general formula (B) (water-soluble polymerization initiator) is preferable.

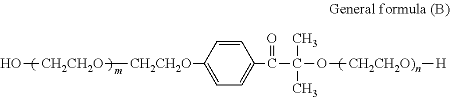

In the general formula (B), n and m respectively independently represent integers of 0 or greater, and m+n represents an integer of 0 to 3.

In the general formula (B), it is preferable that m be 0 to 3, and n be 0 or 1, and more preferable that m be 0 or 1 and n be 0.

Specific examples of the compound represented by the general formula (B) are shown below; however, the present invention is not limited thereto.

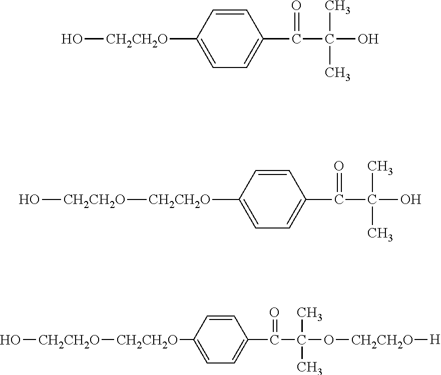

The compound represented by the general formula (B) may be the compound synthesized according to the disclosure in JP2005-307198A or the like, or may be a commercially available compound. As the commercially available compound represented by the general formula (B), for example, Irgacure 2959 (m=0, n=0) can be exemplified.

The content of the polymerization initiator in the ink composition of the present invention is not particularly limited; however, with respect to the total amount of the polymerizable compound (for example, the total amount of the polymerizable compound represented by the general formula (1) and the N-vinyl lactam compound), 1 to 40% by mass is preferable, and 5 to 30% by mass is more preferable. When the content of the polymerization initiator is 1% by mass or more, the rubfastness of the image is further improved and it is advantageous for high-speed recording and when 40% by mass or less, it is advantageous from the viewpoint of ejection stability. Further, when the content of the polymerization initiator is 1% by mass or more, the color reproduction range of the image is further expanded.

As the sensitizer, amine-based compounds (aliphatic amines, amines including aromatic groups, piperidine, and the like); ureas (allyl-based, o-tolylthio ureas, and the like); sulfur compounds (sodium diethyl dithiophosphate, soluble salts of aromatic sulfinic acids, and the like); nitrile compounds (N,N-disubstituted p-aminobenzonitrile, and the like); phosphorus compounds (tri-n-butylphosphine, sodium diethyl dithiophosphate, and the like); nitrogen compounds (Michler's ketone, N-nitrosohydroxylamine derivatives, oxazolidine compounds, tetrahydro-1,3-oxazine compounds, formaldehyde, condensates of acetaldehyde and diamines, and the like); chlorine compounds (carbon tetrachloride, hexachloroethane, and the like); polymerized amines of the reaction products of epoxy resins and amines; triethanolamine triacrylate; and the like, may be exemplified.

The sensitizer can be contained in a range that does not impair the effects of the present invention.

<Water>

The ink composition of the present invention contains water.

In other words, the ink composition of the present invention is an aqueous ink composition.

The content of water in the ink composition of the present invention is not particularly limited; however, with respect to the total mass of the ink composition, 10% by mass or more is preferable, 30% by mass or more is more preferable, 50% by mass or more is even more preferable, and 60% by mass or more is particularly preferable.

In aqueous curable-type ink compositions of the related art, a phenomenon in which the color reproduction range is narrowed as the content of the water is increased is more apt to occur. Accordingly, in a case where the content of the water in the ink composition of the present invention is 10% by mass or more (more preferably 30% by mass or more, even more preferably 50% by mass or more, and particularly preferably 60% by mass or more), the effect of expanding the color reproduction range according to the present invention can be attained more effectively.

The upper limit of the water content is not particularly limited; however, 90% by mass is preferable, and 80% by mass is more preferable.

<Resin Particles>

The ink composition of the present invention can contain resin particles if necessary.

These resin particles preferably have a function of solidifying the ink composition by destabilizing the dispersion and aggregating to increase the viscosity of the ink composition when placed into contact with a processing liquid described below or a region where this has dried. Such resin particles are preferably dispersed in water and at least one kind of organic solvent.

As the resin particles, acrylic resins, vinyl acetate resins, styrene-butadiene resins, vinyl chloride resin, acrylic-styrene resins, butadiene resins, styrene resins, crosslinked acrylic resins, crosslinked styrene resins, benzoguanamine resins, phenolic resins, silicone resins, epoxy resins, urethane resins, paraffin resins, fluorine-based resins, and the like, or latexes thereof can be used. As preferable examples, the acrylic resins, acrylic-styrene resins, styrene resins, crosslinked acrylic resins, and crosslinked styrene resins can be exemplified.

Further, the resin particles can also be used in latex form.

The weight average molecular weight of the resin particles is preferably 10,000 or more and 200,000 or less, and more preferably 20,000 or more and 200,000 or less.

Further, the average particle diameter of resin particles is preferably in a range of 1 nm to 1 μm, more preferably in a range of 1 nm to 200 nm, even more preferably in a range of 1 nm to 100 nm, and particularly preferably in a range of 1 nm to 50 nm.

The glass transition temperature Tg of the resin particles is preferably 30° C. or more, more preferably 40° C. or more, and even more preferably 50° C. or more.

As the resin particles, the use of particles of self-dispersing resin (self-dispersing resin particles) is preferable.

Here, the self-dispersing resin refers to a water-insoluble polymer capable of entering a dispersed state in an aqueous medium according to a functional group (particularly, an acidic group or a salt thereof) belonging to the polymer itself when set to a dispersed state using a phase-transfer emulsification method without the presence of a surfactant.

Here, the dispersed state is one including both of an emulsified state (emulsion) in which the water-insoluble polymer is dispersed in a liquid state in an aqueous medium, and a dispersed state (suspension) in which the water-insoluble polymer is dispersed in a solid state in the aqueous medium.

As the self-dispersing resin particles, it is possible to use the self-dispersing resin particles disclosed in paragraphs 0090 to 0121 of JP2010-64480A and paragraphs 0130 to 0167 of JP2011-068085A.

As the molecular weight of the water-insoluble polymer configuring the self-dispersing resin particles, by weight average molecular weight, 3000 to 200,000 is preferable, 5000 to 150,000 is more preferable, and 10,000 to 100,000 is even more preferable. By setting the weight average molecular weight to 3000 or more, it is possible to effectively suppress the amount of water-soluble components. In addition, by setting the weight average molecular weight to 200,000 or less, it is possible to increase the self-dispersion stability.

Here, the weight average molecular weight of the water-insoluble polymer is measured by gel permeation chromatography (GPC). The GPC used an HLC-8220 GPC (manufactured by Tosoh Co., Ltd.), used three columns of TSKgel SuperHZM-H, TSKgel SuperHZ4000, TSKgel SuperHZ2000 (manufactured by Tosoh Co., Ltd. 4.6 mmID×15 cm) as columns, and used THF (tetrahydrofuran) as an eluent. In addition, the conditions were set to a sample concentration of 0.35% by mass, a flow rate of 0.35 ml/min, a sample introduction amount of 10 μl, and a measurement temperature of 40° C., and the GPC was performed using an IR detector. In addition, the calibration curve was created from eight samples of “Standard Sample TSK standard, polystyrene” manufactured by Tosoh Co., Ltd.: “F-40”, “F-20”, “F-4”, “F-1”, “A-5000”, “A-2500”, “A-1000”, and “n-propylbenzene”.

From the viewpoint of hydrophilic control or hydrophobic control of the polymer, the water-insoluble polymer configuring the particles of the self-dispersing resin preferably includes 15 to 80% by mass of the total mass of the self-dispersing polymer particles as the ratio of copolymerizing structure units derived from aromatic group-containing (meth)acrylate monomers (preferably, structure units derived from phenoxyethyl(meth)acrylate and/or structure units derived from benzyl(meth)acrylate).

Further, from the viewpoint of hydrophilic control or hydrophobic control of the polymer, the water-insoluble polymer preferably includes 15 to 80% by mass of structural units derived from an aromatic group-containing (meth)acrylate monomer as the copolymerization ratio, structural units derived from a carboxyl group-containing monomer, and structural units derived from an alkyl group-containing monomer (preferably, structural units derived from an alkyl(meth)acrylate ester); more preferably includes 15 to 80% by mass of structural units derived from phenoxyethyl(meth)acrylate and/or structural units derived from benzyl(meth)acrylate as the copolymerization ratio, structural units derived from a carboxyl group-containing monomer, and structural units derived from an alkyl group-containing monomer (preferably, structural units derived from an alkyl(meth)acrylate ester with 1 to 4 carbon atoms); and, furthermore, it is preferable that the acid value be 25 to 100 mg KOH/g and the weight average molecular weight be 3000 to 200,000, and more preferable that the acid value be 25 to 95 mg KOH/g and the weight average molecular weight be 5000 to 150,000.

For example, the content of the resin particles (self-dispersing resin particles) is preferably 0.1 to 20% by mass and more preferably 0.1 to 10% by mass, with respect to the total mass of the ink composition.

Further, there is no particular limitation relating to the particle size distribution of the resin particles, and any one having a wide particle size distribution or having a monodispersed particle size distribution is sufficient. Further, two or more kinds of resin particles having a monodispersed particle size distribution may be mixed and used.

<Surfactant>

The ink composition of the present invention preferably contains at least one kind of surfactant. The surfactant can be used as a surface tension adjusting agent.

As the surface tension adjusting agent, it is possible to effectively use a compound or the like having a structure having a combination of a hydrophilic part and a hydrophobic part in the molecule, and it is possible to use any of anionic surfactants, cationic surfactants, amphoteric surfactants, nonionic surfactants, and betaine-based surfactants.

As specific examples of the surfactant, in hydrocarbons, anionic surfactants such as fatty acid salts, alkyl sulfate ester salts, alkyl benzenesulfonate salts, alkyl naphthalenesulfonate salts, dialkyl sulfosuccinate salts, alkyl phosphate esters, formalin naphthalenesulfonate condensates, polyoxyethylene alkyl sulfate ester salts; nonionic surfactants such as polyoxyethylene alkyl ether, polyoxyethylene alkyl allyl ether, polyoxyethylene fatty acid esters, sorbitan fatty acid ester, polyoxyethylene sorbitan fatty acid esters, polyoxyethylene alkyl amines, glycerin fatty acid esters, and oxyethylene oxypropylene block copolymers, are preferable. In addition, SURFYNOLS (manufactured by Air Products & Chemicals), which is an acetylene-based polyoxyethylene oxide surfactant, is also preferably used. Further, amine oxide type amphoteric surfactants such as N,N-dimethyl-N-alkylamine oxide are also preferable.

In addition, those exemplified as surfactants in page (37) to (38) of JP1984-157636A (JP-S59-157636A), Research Disclosure No. 308119 (1989) can be used.

In addition, by using fluorine-based (alkyl fluoride based) surfactants, silicone-based surfactants, and the like described in the respective publications JP2003-322926A, JP2004-325707A, and JP2004-309806, it is possible to improve the scratch resistance.

In addition, these surfactants can also be used as antifoaming agents, and it is also possible to use chelating agents and the like represented by fluorine-based compounds, silicone-based compounds, and EDTA.

As the surfactant, from the viewpoint of more effectively attaining the effects of the present invention, a nonionic surfactant is preferable, and, among these, acetylene glycol-based surfactants are more preferable.

As acetylene glycol-based surfactants, for example, 2,4,7,9-tetramethyl-5-decyne-4,7-diol, and alkylene oxide adducts or the like of 2,4,7,9-tetramethyl-5-decyne-4,7-diol can be exemplified, and it is preferable that the surfactant be at least any one kind selected therefrom. As commercially available products of these compounds, for example, the E series such as Olfine E1010 by Nissin Chemical Industry can be exemplified.

When a surfactant (surface tension adjusting agent) is contained in the ink composition, from the viewpoint of favorably performing ejection of the ink composition in an ink jet manner, the surfactant is preferably contained in an amount of a range which can adjust the surface tension of the ink composition to 20 to 60 mN/m. The surface tension is more preferably 20 to 45 mN/m, and even more preferably 25 to 40 mN/m.

The specific amount of surfactant with respect to the total mass of the ink composition is not particularly limited; however, 0.1% by mass or more is preferable, 0.1 to 10% by mass is more preferable, and 0.2 to 3% by mass is even more preferable.

<Other Components>

The ink composition of the present invention may also contain other components if necessary.

As the other components, for example, known additives such as polymerization inhibitors, anti-drying agents (wetting agents), antifading agents, emulsion stabilizers, penetration enhancers, ultraviolet absorbing agents, preservatives, fungicides, pH adjusting agents, antifoaming agents, viscosity-adjusting agents, dispersion stabilizers, rust inhibitors, chelating agent and the like may be exemplified.

Each type of these additives is directly added to the ink in the case of the ink composition, furthermore, in the case of using an oil dye as a dispersoid, the addition to the dispersoid is usually made after preparation of the dye dispersoid; however, the addition may be made to the aqueous phase or the oil phase during preparation.

The ultraviolet absorbing agent can improve the storability of the image. As the ultraviolet absorbing agent, benzotriazole compounds disclosed in JP1983-185677A (JP-S58-185677A), JP1986-190537A (JP-S61-190537A), JP1990-782A (JP-H02-782A), JP1993-197075A (JP-H05-197075A), JP1997-34057A (JP-H09-34057A), and the like; benzophenone compounds disclosed in JP1971-2784A (JP-S46-2784A), JP1993-194483A (JP-H05-194483A), U.S. Pat. No. 3,214,463A, and the like; cinnamic acid compounds disclosed in JP1973-30492B (JP-S48-30492B), JP1981-21141B (JP-S56-21141B), JP1998-88106A (JP-H10-88106A), and the like; triazine compounds disclosed in JP1992-298503A (JP-H04-298503A), JP1996-53427A (JP-H08-53427A), JP1996-239368A (JP-H08-239368A), JP1998-182621A (JP-H10-182621A), JP1996-501291A (JP-H08-501291A), and the like; and compounds absorbing ultraviolet rays and emitting fluorescence, that is, fluorescent brightening agents (represented by the compounds disclosed in Research Disclosure No. 24239, stilbene-based compounds, and benzoxazole-based compounds) can be used.

The antifading agent can improve the storability of the image. As the antifading agent, various types of organic and metal complex antifading agents may be exemplified. As organic antifading agents, hydroquinones, alkoxy phenols, dialkoxy phenols, phenols, anilines, amines, indans, chromans, alkoxyanilines, heterocycles and the like may be exemplified; as the metal complex antifading agents, nickel complexes, zinc complexes and the like, may be exemplified. More specifically, it is possible to use the compounds disclosed in the patents cited in pages I to J of No. VII of Research Disclosure No. 17643, Research Disclosure No. 15162, the left column of page 650 of Research Disclosure No. 18716, page 527 of Research Disclosure No. 36544, page 872 of Research Disclosure No. 307105, and Research Disclosure No. 15162, and compounds included in the general formulas and compound examples of representative compounds disclosed in pages 127 to 137 of JP1987-215272A (JP-S62-215272A).

As the fungicide, sodium dehydroacetate, sodium benzoate, sodium pyridinethione-1-oxide, ethyl ester of p-hydroxybenzoic acid, 1,2-benzisothiazolin-3-one and salts thereof or the like, may be exemplified. The content of the fungicide is preferably in the range of 0.02 to 1.00% by mass with respect to the total mass of the ink composition.

As the pH adjusting agent, a neutralizing agent (organic base, inorganic alkali) can be used. The pH adjusting agent can improve the storage stability of the ink composition. The pH adjusting agent is preferably added so that the pH of the ink composition becomes 6 to 10, and more preferably added so that the pH of the ink composition becomes 7 to 10.

In addition, the ink compositions of the present invention may include a water-soluble solvent in addition to water, in a range that does not impair the effects of the present invention. As the water-soluble solvent, for example, glycerin, ethylene glycol, diethylene glycol, diethylene glycol monoethyl ether, tripropylene glycol monomethyl ether, 1,2-hexanediol and the like can be used. In addition, as the water-soluble solvent, for example, known water-soluble organic solvents disclosed in paragraphs 0124 to 0135 of JP2011-074150A and paragraphs 0104 to 0119 of JP2011-079901A, or the like can be used.

<<Ink Set>>

The ink set of the present invention includes the previously mentioned ink composition of the present invention, and a processing liquid including a flocculant causing the components in the ink composition to aggregate.

The phenomenon whereby the color reproduction range is narrowed in images using conventional aqueous curable-type ink is particularly remarkable in a system of forming images using an ink set including conventional aqueous curable-type ink and a processing liquid including a flocculant causing the components in the aqueous curable-type ink to aggregate. Accordingly, according to the ink set of the present invention, the effect of expanding the color reproduction range using the ink composition of the present invention is more effectively attained.

The ink set of the present invention may include only one kind (one color) of ink composition of the present invention described above, or may include two kinds or more (two or more colors).

The ink set of the present invention may include only one kind of the processing liquid, or may include two kinds or more.

Further, the ink set of the present invention may include other constituent elements such as an ink composition other than the ink composition of the present invention (below, sometimes referred to as “second ink composition”) and the like in addition to the ink composition of the present invention (below, sometimes referred to as “first ink composition”) and the processing liquid. Here, the details of the second ink composition will be described later.

(Processing Liquid)

The processing liquid includes at least a flocculant causing the components in the previously described ink composition (preferably, the first ink composition and the second ink composition) to aggregate; however, as necessary, it can be configured using still other components. By using the processing liquid along with the ink composition, it is possible to increase the speed of the ink jet recording, and an image which has excellent density and high-resolution drawing (for example, the reproducibility of fine lines and minute portions) even with high-speed recording is obtained.

The flocculant may be a compound that can change the pH of the ink composition, a polyvalent metal salt, or a polymer having a quaternary or tertiary amine such as a polyallylamine. In the present invention, from the viewpoint of the aggregability of the ink composition, a compound that can change the pH of the ink composition is preferable, and a compound that can reduce the pH of the ink composition is more preferable.

As the compound that can reduce the pH of the ink composition, acidic substances can be exemplified.

As the acidic substances, for example, sulfuric acid, hydrochloric acid, nitric acid, phosphoric acid, polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, or derivatives or salts thereof, and the like may be suitably exemplified.

One acidic substance may be used alone or a mixture of two or more may be used.

When the processing liquid in the present invention includes an acidic substance, the pH (25° C.) of the processing liquid is preferably 6 or less, and more preferably, the pH is 4 or less. Among these, the pH (25° C.) is more preferably in the range of 0.5 to 4. It is even more preferable that the pH be in the range of 1 to 4, and particularly preferably, 1 to 3. At this time, the pH (25° C.) of the ink composition is preferably 7.5 or more (more preferably 8.0 or more).

Among these, from the viewpoints of image density, resolution, and increasing the speed of the ink jet recording, a case where the pH (25° C.) of the ink composition is 8.0 or more and the pH of the processing liquid is 0.5 to 4 is more preferable.

Among these, as the flocculant in the present invention, an acidic substance with high water solubility is preferable, and, from the viewpoint of increasing aggregability and fixing the entirety of the ink, an organic acid is preferable, a divalent or higher organic acid is more preferable, and an acidic substance which is divalent or higher and trivalent or lower is particularly preferable. As the divalent or higher organic acid, an organic acid having a first pKa of 3.5 or less is preferable, and an organic acid having 3.0 or less is more preferable. Specifically, for example, phosphoric acid, oxalic acid, malonic acid, citric acid and the like may be suitably exemplified.

As the polyvalent metal salt, alkaline earth metals of the second group of the periodic table (for example, magnesium, calcium), transition metals of the third group of the periodic table (for example, lanthanum), cations of the thirteenth group of the periodic table (for example, aluminum), and salts of lanthanides (for example, neodymium) can be exemplified. As the salts of these metals, carboxylates (formate, acetate, and benzoate, or the like), nitrate salt, chlorides, and thiocyanates are suitable. Among them, the following are preferable: calcium salts or magnesium salts of carboxylates (formate, acetate, and benzoate, and the like); calcium salts or magnesium salts of nitrates; calcium chloride; magnesium chloride; and calcium salts or magnesium salts of thiocyanic acid.

The flocculant can be used alone as a single kind, or two or more kinds can be mixed.

As the content of the flocculant, which causes the components in the ink composition to aggregate, in the processing liquid, a range of 1 to 50% by mass is preferable, 3 to 45% by mass is more preferable, and 5 to 40% by mass is even more preferable.

The processing liquid can also contain other additives as components other than these in a range which does not impair the effect of the invention. As other additives, for example, known additives such as anti-drying agents (wetting agents), antifading agents, emulsion stabilizers, penetration enhancers, ultraviolet absorbing agents, preservatives, fungicides, pH adjusting agents, surfactants (surface tension adjusting agents), antifoaming agents, viscosity-adjusting agents, dispersants, dispersion stabilizers, rust inhibitors, chelating agents and the like may be exemplified.

<<Image Forming Method>>

The image forming method of the present invention uses the previously described ink set of the present invention and includes: a processing liquid adding step of adding a processing liquid onto a recording medium, an ink adding step of adding an ink composition onto the processing liquid added onto the recording medium, and an active energy ray irradiating step of irradiating active energy rays to the ink composition added onto the recording medium. The image forming method of the present invention can be configured to have other steps as necessary.

The phenomenon whereby the color reproduction range is narrowed in images using conventional aqueous curable-type ink is particularly remarkable in a system of forming images using an ink set including conventional aqueous curable-type ink and a processing liquid including a flocculant causing the components in the aqueous curable-type ink to aggregate. Accordingly, according to the image forming method of the present invention, the effect of expanding the color reproduction range using the ink composition of the present invention is more effectively attained.

Below, each step configuring the image forming method of the present invention will be described.

<Processing Liquid Adding Step>

The processing liquid adding step in the present invention is a step of adding a processing liquid including a flocculant causing the components in the ink composition to aggregate onto a recording medium.

Here, the processing liquid contains at least a flocculant, and the details and preferable embodiments of each component are as previously described.

The adding of the processing liquid can be performed by applying a well-known method such as a coating method, an ink jet recording method, or a dipping method. As the coating method, it is possible to use well-known coating methods using a bar coater, an extrusion die coater, an air doctor coater, a blade coater, a rod coater, a knife coater, a squeeze coater, a reverse roll coater, and the like. The details of the ink jet recording method will be fully described in the following description of the ink adding step.

The addition amount of the processing liquid is not particularly limited as long as it is capable of aggregating the components in the ink composition; however, preferably, it is possible to set the amount to one at which the addition amount of the flocculant becomes 0.1 g/m² or more. Among these, an amount at which the addition amount of the flocculant becomes 0.2 to 0.7 g/m² is more preferable. When the addition amount of the flocculant is 0.1 g/m² or more, it is possible to maintain favorable high-speed aggregability according to the various types of use of the ink composition. In addition, it is preferable that the addition amount of the flocculant be 0.7 g/m² or less from the viewpoint that there is no adverse influence (change in the gloss, or the like) on the surface property of the added recording medium.

(Processing Liquid Drying Step)

Further, in the present invention, between the processing liquid adding step and the ink adding step, that is, after adding the processing liquid onto the recording medium, it is preferable that a processing liquid drying step of drying the processing liquid on the recording medium be further provided in the time until the ink composition is added. By drying the processing liquid in advance before the ink adding step, the ink colorability such as bleeding prevention becomes favorable and it is possible to record a visible image with a favorable color density and hue.

As the form of the drying, drying by heating is preferable.

The drying by heating can be performed by well-known heating means such as a heater, air blowing means for using blown air such as a dryer, or means for combining these. As the heating method, for example, a method of applying heat with a heater or the like from the opposite side to the side of adding the processing liquid on the recording medium, a method of blowing warm air or hot air onto the side of adding the processing liquid on the recording medium, a heating method using an infrared heater or the like may be exemplified, and heating may be performed using a combination of a plurality of these.

(Recording Medium)

The image forming method of the present invention records an image on a recording medium.

The recording medium is not particularly limited; however, it is possible to use paper for general printing mainly composed of cellulose such as so-called high-quality paper, coated paper, and art paper used in general offset printing and the like. In image recording according to a general ink jet recording method using aqueous ink, the paper for general printing mainly composed of cellulose is comparatively slow to absorb and dry ink, movement of the color material after ejecting is apt to occur, and the image quality is easily deteriorated; however, according to the image forming method of the present invention, movement of the color material is suppressed and it is possible to record a high-quality image with excellent color density and hue.

As the recording medium, it is possible to use the ones which are generally commercially available, for example, high quality paper (A) such as “OK Prince High Quality” manufactured by Oji Paper Co., Ltd., “Shiorai” manufactured by Nippon Paper Industries Co., Ltd., and “New NPI high quality” manufactured by Nippon Paper Industries Co., Ltd.; fine coated paper such as “OK Everlight Coat” manufactured by Oji Paper Co., Ltd. and “Aurora S” manufactured by Nippon Paper Industries Co., Ltd.; lightweight coated paper (A3) such as “OK Coat L” manufactured by Oji Paper Co., Ltd. and “Aurora L” manufactured by Nippon Paper Industries Co., Ltd.; coated paper (A2, B2) such as “U-LITE” manufactured by Nippon Paper Industries Co., Ltd., “OK Top Coat +” manufactured by Oji Paper Co., Ltd. and “Aurora Coat” manufactured by Nippon Paper Industries Co., Ltd.; and art paper (A1) such as “OK Kinfuji +” manufactured by Oji Paper Co., Ltd. and “Tokubishi Art” manufactured by Mitsubishi Paper Mills Ltd., may be exemplified. Further, it is also possible to use a variety of types of photo paper for ink jet recording.

Among the recording media, that known as coated paper used for general offset printing and the like is preferable. Coated paper is provided with a coating layer by coating a coating material on the surface of high-quality paper, neutral paper or the like mainly composed of cellulose and generally not surface processed. In image forming using a normal ink jet recording method with an aqueous ink, coated paper is apt to suffer problems relating to quality such as image gloss, resistance to scratch, and the like; however, in the image forming method of the present invention, it is possible to suppress uneven gloss and obtain an image having a favorable gloss characteristic and scratch resistance characteristic. In particular, it is preferable to use coated paper having a base sheet and a coating layer including an inorganic pigment, and it is more preferable to use coated paper having a base sheet and a coated layer including kaolin and/or calcium bicarbonate. Specifically, art paper, coated paper, lightweight coated paper, or fine coated paper are more preferable.

<Ink Adding Step>

The ink adding step of the present invention is a step of adding the ink composition of the present invention onto the processing liquid added onto the recording medium.

In the ink adding step, by the contact of the processing liquid added in the previously described processing liquid adding step and the ink composition added in the present step, the dispersed particles of the pigment or the like in the ink composition are aggregated and an image is fixed onto the recording medium. In this manner, it is possible to increase the speed of the image recording, and an image which has excellent density and high-resolution even with high-speed recording is obtained.

The details of the ink composition such as the preferable embodiments of the ink composition are as described in the description relating to the previously described ink composition.

The adding of the ink composition in the present step can be performed using an ink jet recording method.

The recording of the image using the ink jet recording method can specifically be performed by ejecting a liquid composition and applying energy to a desired recording medium, that is, normal paper, resin coated paper, for example, the ink jet paper, film, electrophotography common-use paper, cloth, glass, metal, pottery, and the like disclosed in JP1996-169172A (JP-H08-169172A), JP1996-27693A (JP-H08-27693A), JP1990-276670A (JP-H02-276670A), JP1995-276789A (JP-H07-276789A), JP1997-323475A (JP-H09-323475A), JP1987-238783A (JP-S62-238783A), JP1998-153989A (JP-H10-153989A), JP1998-217473A (JP-H10-217473A), JP1998-235995A (JP-H10-235995A), JP1998-337947A (JP-H10-337947A), JP1998-217597A (JP-H10-217597A), JP1998-337947A (JP-H10-337947A), and the like. Here, as a preferable ink jet recording method in the present invention, the method disclosed in paragraphs 0093 to 0105 of JP2003-306623A can be applied.

The ink jet recording method is not particularly limited and may be any well-known method such as, for example, an electric charge control method using electrostatic attraction to eject ink, a drop-on-demand method (pressure pulse method) using vibration pressure of piezo elements, a sound ink jet method changing an electrical signal into a sound beam, irradiating ink and ejecting the ink using radiation pressure, and a thermal ink jet (bubble jet (registered trademark)) method heating the ink, forming bubbles, and using the generated pressure. As the ink jet recording method, in particular, it is possible to effectively use an ink jet recording method in which, using the method disclosed in JP1979-59936A (JP-S54-59936A), the ink is changed in volume quickly by receiving the action of the heat energy, and, is ejected from a nozzle due to the acting force according to this state change.

Here, the ink jet recording methods include a method of ejecting low density ink known as photo ink in a small volume many times, a method of improving the image quality using a plurality of inks of different densities with substantially the same color, and a method of using colorless transparent ink.

Further, the ink jet head used in the ink jet recording method may be an on-demand type or may be a continuous type. Further, as the ejection method, an electrical-mechanical conversion method (for example, single cavity-type, double cavity-type, vendor-type, piston-type, shear mode-type, shared wall-type, and the like), an electric-thermal conversion method (for example, thermal ink jet-type, bubble jet (registered trademark) type, and the like), an electrostatic attraction method (for example, an electric field control-type, a slit jet-type, and the like), a discharge method (for example, a spark jet type, and the like), and the like can be exemplified as specific examples; however, any of these ejection methods may be used.

Here, the ink nozzles and the like used during the performing of the recording using the ink jet recording method are not particularly limited; however, they may be appropriately selected according to the purpose.

Specific examples of the ink jet recording method are shown below.

As an ink jet recording method, there is a method called the (1) electrostatic attraction method. The electrostatic attraction method is a method of making ink droplets fly toward a recording medium, fixing the ink droplets on the recording medium and recording an image by applying a strong electric field between a nozzle and an acceleration electrode arranged in front of the nozzle, causing droplet-shaped ink to be continuously ejected from the nozzle, and applying a printing information signal to deflection electrodes while the ink droplets are passing between the deflection electrodes, or a method of fixing and recording an image on a recording medium by ejecting ink droplets from a nozzle onto a recording medium according to a printing information signal without deflecting the ink droplets. In addition, (2) there is a method of forcibly ejecting ink droplets from a nozzle by applying pressure to the ink droplets using a small pump and mechanically vibrating the nozzle using a quartz resonator or the like. In this method, ink droplets ejected from the nozzle are charged at the same time as they are ejected, a printing information signal is applied to the deflection electrodes while the ink droplets pass between the deflection electrodes and the ink droplets are made to fly toward the recording medium, whereby an image is recorded on the recording medium. Next, (3) there is a method (piezo) of applying pressure and a printing information signal to the ink liquid at the same time using a piezoelectric element, ejecting ink droplets from the nozzle toward the recording medium, and recording an image on the recording medium and (4) a method (bubble jet (registered trademark)) which heats and foams ink liquid using microelectrodes according to printing signal information, ejects the ink liquid from the nozzle toward the recording medium using the expansion of the bubbles, and records an image on the recording medium.

As an ink jet head, there is a shuttle type using a short serial head (short head) and performing recording while causing the serial head to scan in the width direction of the recording medium and a line type using a line head in which recording elements are arranged corresponding to the entire area of one side of the recording medium. In the line type, it is possible to perform image recording over the whole surface of the recording medium by scanning the recording medium in the direction intersecting the arrangement direction of the recording elements and a transport system for a carriage or the like scanning the short head is unnecessary. In addition, since complicated scanning control of the movement of the carriage and the recording medium is unnecessary and only the recording medium is moved, it is possible to realize an increase in the recording speed in comparison with the shuttle type.

The image forming method of the present invention can be applied to any of these; however, generally, in the case of application to a line type which does not perform a dummy jet, the color reproduction expansion effect according to the present invention is great.

As the ink droplet amount ejected from the nozzle, from the viewpoint of obtaining high-definition images, 1 to 10 pl (picoliters) is preferable, and 1.5 to 6 pl is more preferable. In addition, from the viewpoint of improving the unevenness of the image and the connection of the continuous tone, it is also effective to combine and eject different droplet amounts and the present invention can be favorably used even in these cases.

<Active Energy Ray Irradiating Step>

The active energy ray irradiating step in the present invention is a step of irradiating active energy rays to the ink composition added onto the recording medium (specifically, onto the processing liquid added to the recording medium) in the ink adding step.

In the present step, the polymerizable compound (that is, the compound represented by the general formula (1) and the N-vinyl lactam compound) in the ink composition is polymerized by the irradiation of the active energy rays and a cured film including a pigment is formed. In this manner, the scratch resistance characteristic of the formed image is further improved.

The active energy rays used in the present invention are not particularly limited as long as the active energy rays are capable of polymerizing the polymerizable compound. For example, ultraviolet rays, electron beams, and the like can be exemplified, and, among these, from the viewpoint of versatility, ultraviolet rays are preferable.

—Ultraviolet Ray Irradiating Lamp—

As means for irradiating ultraviolet rays, it is possible to use any means which is normally used, in particular, an ultraviolet ray irradiating lamp may be suitably used.

The ultraviolet ray irradiating lamp is preferably one in which the mercury vapor pressure is 1 to 10 Pa when lit such as a so-called low pressure mercury lamp, a high pressure mercury lamp, a mercury lamp coated with phosphor, a UV-LED light source, or the like. The emission spectrum of the ultraviolet ray region of these mercury lamps and the UV-LED light source is 450 nm or less, more particularly, is a range of 184 nm to 450 nm, and is suitable for efficiently causing the polymerizable compound to react in a black or colored ink composition. Further, it is suitable because it is possible to use a small power source when mounting a power source on the printer. In the mercury lamp, for example, metal halide lamps, high-pressure mercury lamp, ultra-high pressure mercury lamps, xenon flash lamps, deep UV lamps, lamps exciting mercury lamps without electrodes from outside using microwaves, UV lasers, and the like have been put into practical use. Since the above-described range is included as the emission wavelength region of these lamps, as long as the size of the power source, the input intensity, the lamp shape, and the like permit, these are basically applicable. The light source is also selected to match the sensitivity of the polymerization initiator to be used.

The necessary ultraviolet ray intensity is preferably 500 to 5000 mW/cm² in a wavelength region effective for curing. If the irradiation intensity is weak, the formation of a high-quality, robust image may not be achieved. In addition, if the irradiation intensity is too strong, the target recording medium may be damaged or the color material may be faded.

(Ink Drying Step)

In the image forming method of the present invention, before the active energy ray irradiating step following the ink adding step, it is preferable to further have an ink drying step of drying the ink composition added onto the recording medium.

In the ink drying step, a liquid medium (preferably, at least water) included in the ink composition is removed. By having the drying step, the polymerization efficiency of the polymerizable compound included in the ink composition is improved and it is possible to form an image in higher definition having an excellent scratch resistance characteristic.

There are no particular limitations on the removal method of the liquid medium (preferably, at least water) included in the ink composition and it is possible to apply a normally used medium removal method. In particular, from the viewpoint of the removal efficiency of the medium, removal of the medium by a heating process is preferable.

<<Preferable Embodiment of the Image Forming Method>>

Next, description will be given of a preferable embodiment of the image forming method of the present invention described above.

The image forming method according to the present embodiment is based on the image forming method of the present invention described above in which the ink adding step includes a first ink adding step of adding a first ink composition, which is the ink composition of the present invention, on the processing liquid added onto the recording medium and a second ink adding step of adding a second ink composition containing a pigment, a polymerizable compound, a polymerization initiator, and water onto the added first ink composition (so as to overlap at least a part of the first ink composition), and the active energy ray irradiating step is a step of irradiating active energy rays to the ink compositions of a plurality of colors including the first ink composition and the second ink composition added onto the recording medium.

The present embodiment is an aspect of forming an image of multiple colors (preferably 2 to 4 colors) by overlapping and adding ink compositions of a plurality of colors including the first ink composition and the second ink composition on the recording medium.

As the results of studies of the present inventors, the phenomenon in which the color reproduction range in an image using aqueous curable-type ink of the related art is narrowed is particularly remarkably apparent in a system forming an image of multiple colors in which a plurality of ink compositions overlap.

Accordingly, according to the present embodiment, the color reproduction range expansion effect according to the ink composition of the present invention is particularly remarkably attained.

In the present embodiment, in a case where a plurality of colors of ink compositions are overlapped and added to form an image of multiple colors, the second ink composition indicates an ink composition of the uppermost layer (layer furthest separated when seen from the recording medium).

The second ink composition is not particularly limited as long as it is an ink composition including a pigment, a polymerizable compound, a polymerization initiator, and water (that is, aqueous curable-type ink), and may be the ink composition of the present invention or may be an ink composition other than the ink composition of the present invention. That is, the pigment, polymerizable compound, polymerization initiator, and the like included in the second ink composition may be the same as or different from those exemplified as the pigment, polymerizable compound, polymerization initiator, and the like configuring the first ink composition.

However, using the ink composition of the present invention as the second ink composition is preferable from the viewpoint of being able to form an image of multiple colors while arbitrarily selecting the droplet ejection order (adding order) of the ink composition of each color (for example, using ink compositions of four colors of cyan (C), magenta (M), yellow (Y), and black (K)).

When the second ink composition is an ink composition other than the ink composition of the present invention, it is possible to use the same components as the components of the ink composition of the present invention as the components other than the polymerizable compound.

In a case where the second ink composition is an ink composition other than the ink composition of the present invention, it is possible to use polymerizable compounds well known in the Technical Field of the curable-type ink composition such as monofunctional acrylamides (such as hydroxyethyl acrylamide), monofunctional or polyfunctional acrylic esters and the like as the polymerizable compound. For example, it is possible to use the polymerizable compound disclosed in paragraphs 0027 to paragraph 0041 of JP2007-262178A as the well-known polymerizable compound.

Further, the first ink composition in the present embodiment indicates an ink composition other than the second ink composition. In other words, in a case where a plurality of colors of ink compositions are overlapped and added to form an image of multiple colors, the first ink composition includes at least an ink composition of the lowermost layer (closest layer when seen from the recording medium).

It is necessary that the first ink composition in the present embodiment be the ink composition of the present invention described above. In this manner, in the case of forming an image of multiple colors, the color reproduction range of the image is effectively expanded.

The first ink composition in the present embodiment is not limited to one type (one color) of ink composition and may be two or more types (two or more colors) of ink compositions.

That is, in a case where the first ink composition is one type (one color) of ink composition, the present embodiment is an aspect of forming an image of two colors.

Further, in a case where the first ink composition is two types (two colors) of ink compositions and ink compositions of three colors combining the two types of ink composition and the second ink composition are overlapped and added, the present embodiment is an aspect of forming an image of three colors.

Further, in a case where the first ink composition is three types (three colors) of ink compositions and ink compositions of four colors combining the three types of ink composition and the second ink composition are overlapped and added, the present embodiment is an aspect of forming an image of four colors.

<<Ink Jet Recording Apparatus>>

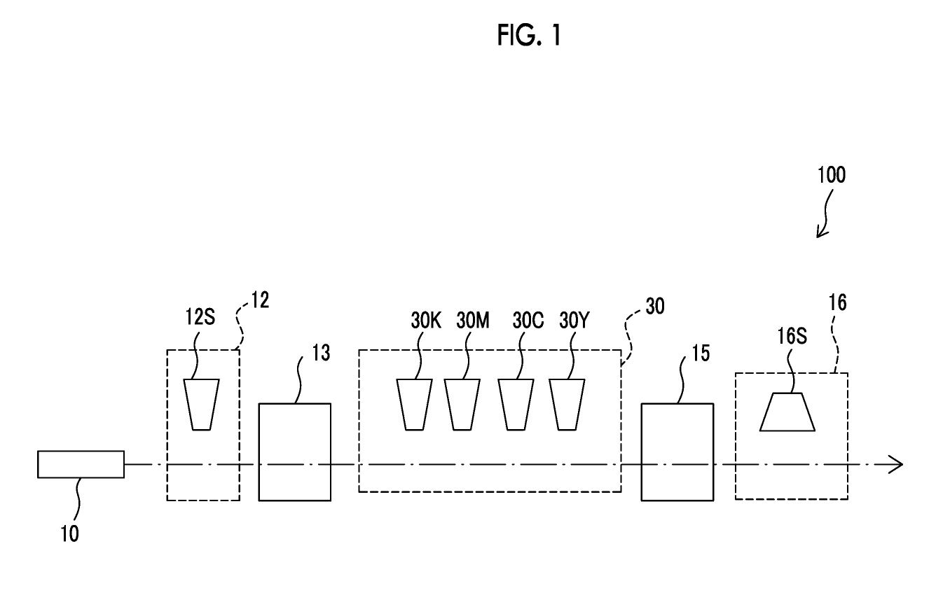

Next, specific description will be given of an example of a suitable ink jet recording apparatus for implementing the image forming method (including the image forming method according to the above-described preferable embodiment) of the present invention with reference to FIG. 1.

FIG. 1 is a schematic configurational diagram showing a configuration example of an entire ink jet recording apparatus 100 according to the example.

As shown in FIG. 1, the ink jet recording apparatus 100 is provided with a transport stage 10 which holds the recording medium and is movable in a predetermined transport direction (in the direction of the arrow of the dot-dashed line in FIG. 1) at a predetermined transport speed, and, along the transport direction of the transport stage 10, is also sequentially provided with a processing liquid adding unit 12 provided with a processing liquid ejecting head 12S ejecting processing liquid onto the recording medium; a processing liquid drying zone 13 causing the added processing liquid to dry; an ink ejection unit 30 in which ink jet heads ejecting each type of ink onto the recording medium are lined up; an ink drying zone 15 causing the ejected ink to dry; and an ultraviolet ray irradiation zone 16 provided with an ultraviolet ray irradiation lamp 16S capable of irradiating ultraviolet rays (UV) onto the recording medium.

Here, the transport stage 10 is configured so as to be able to perform transportation in the opposite direction with respect to the transport direction (in the direction of the arrow of the dot-dashed line in FIG. 1), and configured so as to be able to control the transport distance and the transport speed independently. In the ink jet recording apparatus 100, with these configurations, it becomes possible to arbitrarily set the order of the processes according to each zone and the order of the droplet ejection of ink of each color.

In the processing liquid adding unit 12, a processing liquid ejecting head 12S linked to a storage tank (not shown) storing the processing liquid is provided. The processing liquid ejecting head 12S is set so as to be able to eject processing liquid from ejection nozzles arranged opposite to the recording surface of the recording medium and add liquid droplets of the processing liquid onto the recording medium. Here, the processing liquid adding unit 12 is not limited to a type performing ejection from nozzle-shaped ink jet heads and a coating type using a coating roller can be adopted. This coating type is capable of easily adding processing liquid to approximately the whole surface including the image region where the ink droplets are landed on the recording medium by the ink ejection unit 30 arranged at the downstream side. In order to make the thickness of the processing liquid on the recording medium regular, for example, an air knife may be used, or there may be provided a method such as providing a gap corresponding to a set amount of the processing liquid between the recording medium and the ink ejection unit, and installing a member having sharp corners.

The processing liquid drying zone 13 is arranged at the downstream side of the recording medium transport direction of the processing liquid adding unit 12. The processing liquid drying zone 13 can be configured by well-known heating means such as a heater, air-blowing means for using blown air such as a dryer, or means combining these. For the heating means, a method of installing a heating element such as a heater at the opposite surface side to the image forming surface of the recording medium (specifically, below the transport stage 10 holding the recording medium), a method of blowing warm air or hot air onto the image forming surface of the recording medium, a heating method using an infrared heater, and the like may be exemplified, and heating may be performed by combining a plurality thereof.

Further, since the surface temperature of the recording medium is changed according to the type of the recording medium (material quality, thickness, and the like) or the environmental temperature, it is preferable to provide a measuring unit measuring the surface temperature of the recording medium and a control mechanism giving feedback of the value of the surface temperature of the recording medium measured by the measuring unit to the heating control unit, and to form an interception layer while performing temperature control. As the measuring unit measuring the surface temperature of the recording medium, a contact or non-contact thermometer is preferable.

Further, a solvent removal method using a solvent removal roller or the like may be employed. As other aspects, a method of removing excess solvent from the recording medium with an air knife may be used.

The ink ejection unit 30 is arranged at the downstream side in the recording medium transport direction of the processing liquid drying zone 13. In the ink ejection unit 30, recording heads (ink ejection heads) 30K, 30M, 30C, and 30Y linked to respective ink storage units storing each color ink of black (K), magenta (M), cyan (C), and yellow (Y) are arranged in order. In each ink storage unit (not shown), an ink composition corresponding to each hue is stored and supplied to each ink ejection head 30K, 30M, 30C, and 30Y as necessary when recording an image.

Here, the arrangement order of the recording heads (ink ejection heads) 30K, 30M, 30C, and 30Y is not limited to the arrangement order shown in FIG. 1 and can be changed as appropriate.

Further, although not shown, at the transport direction downstream side of the ink ejection heads 30K, 30M, 30C, and 30Y, one or more other recording heads for ejecting spot color ink can be installed so as to be able to eject spot color ink as necessary.

The ink ejection heads 30K, 30M, 30C, and 30Y eject ink compositions corresponding to the respective images from the ejection nozzles arranged opposite to the recording surface of the recording medium. In this manner, ink compositions of each color are added onto the recording surface of the recording medium and a color image is recorded.

The processing liquid ejection head 12S and the ink ejection head 30K, 30M, 30C, and 30Y are all full line heads with a large number of ejection holes (nozzles) across the maximum recording width (maximum recording width) of the image recorded on the recording medium. In this manner, in comparison with a serial type performing recording while reciprocally scanning a short shuttle head in the width direction (direction intersecting the transport direction on the recording medium transport surface) of the recording medium, it is possible to perform image recording at high speed on the recording medium. In the present invention, a method which is capable of recording with a serial type or comparatively high speed recording, for example, any recording with a method capable of ejecting and recording in a main scanning direction with a single pass forming one line with one scan may be adopted; however, according to the image recording method of the present invention, a high-quality image with good reproducibility may be obtained even with a method using a single pass.

Here, the processing liquid ejection head 12S and the ink ejection heads 30K, 30M, 30C, and 30Y all have the same structure.

The addition amount of the processing liquid and the addition amount of the ink composition are preferably adjusted as necessary. For example, for the adjustment and the like of physical properties such as the viscoelasticity of aggregates in which the processing liquid and the ink composition can be mixed, the addition amount of the processing liquid may be changed.

The ink drying zone 15 is arranged on the recording medium transport direction downstream side of the ink ejection unit 30. The ink drying zone 15 can be configured similarly to the processing liquid drying zone 13.

The ultraviolet ray irradiation zone 16 is arranged further at the downstream side of the recording medium transport direction of the ink drying zone 15, irradiates ultraviolet rays using an ultraviolet ray irradiation lamp 16S provided in the ultraviolet ray irradiation zone 16, and is set to polymerize and cure the monomer components in the image after image drying. The ultraviolet ray irradiation lamp 16S irradiates the entirety of the recording surface using the lamp arranged opposite to the recording surface of the recording medium and is set to be able to perform curing of the entire image. Here, the ultraviolet ray irradiation zone 16 is not limited to the ultraviolet ray irradiation lamp 16S, and can adopt a halogen lamp, a high-pressure mercury lamp, a laser, an LED, an electron beam irradiation apparatus, or the like.

The ultraviolet ray irradiation zone 16 may be installed either before or after the ink drying zone 15 and may be installed both before and after the ink drying zone 15.

In addition, in the ink jet recording apparatus 100, it is possible to arrange the heating means for performing the heating process on the recording medium on the transport path of the transport stage 10. For example, by arranging the heating means at a desired position such as the upstream side of the processing liquid drying zone 13 or between the ink ejection unit 30 and the ink drying zone 15 and heating the recording medium to a desired temperature, it is possible to effectively perform drying and fixing.

### EXAMPLES

Below, the present invention will be described in more detail using examples; however, the present invention is not limited to the following examples as long as it does not exceed the gist thereof. In addition, unless otherwise specified, “parts” are by mass.

<<Preparation of Aqueous Ink>>

As the aqueous ink, cyan ink C1 to C12, magenta ink M1 to M12, yellow ink Y1 to Y12, and black ink K1 to K12 were respectively prepared. Detailed description will be given below.

<Preparation of Cyan Ink C1>

(Preparation of Polymeric Dispersing Agent 1 Solution)

6 parts of styrene, 11 parts of stearyl methacrylate, 4 parts of STYRENE MACROMER AS-6 (trade name, manufactured by Toagosei Co., Ltd.), 5 parts of BLEMMER PP-500 (trade name, manufactured by Nippon Oil & Fats Co., Ltd.), 5 parts of methacrylic acid, 0.05 parts of 2-mercaptoethanol and 24 parts of methyl ethyl ketone were added to a reaction vessel, and a mixed solution was prepared.

On the other hand, 14 parts of styrene, 24 parts of stearyl methacrylate, 9 parts of STYRENE MACROMER AS-6 (trade name, manufactured by Toagosei Co., Ltd.), 9 parts of BLEMMER PP-500 (trade name, manufactured by Nippon Oil & Fats Co., Ltd.), 10 parts of methacrylic acid, 0.13 parts of 2-mercaptoethanol, 56 parts of methyl ethyl ketone and 1.2 parts of 2,2′-azobis(2,4-dimethylvaleronitrile) were added to a dropping funnel and a mixed solution was prepared.

Then, the mixed solution in the reaction vessel was heated to 75° C. under a nitrogen atmosphere while stirring and the mixed solution in the dropping funnel was gradually added dropwise thereto over 1 hour. Two hours after the completion of the dropwise addition, a solution obtained by dissolving 1.2 parts of 2,2′-azobis(2,4-dimethylvaleronitrile) in 12 parts of methyl ethyl ketone was added dropwise thereto over 3 hours, followed by further aging for 2 hours at 75° C. and for 2 hours at 80° C., whereby a polymeric dispersing agent 1 solution was obtained.

A part of the resulting polymeric dispersing agent 1 solution was separated by removing a solvent and the obtained solid content was diluted to 0.1% by mass with tetrahydrofuran, followed by measuring the weight average molecular weight using a high-speed GPC (gel permeation chromatography) HLC-8220GPC with three of TSKgel Super HZM-H, TSKgel Super HZ4000 and TSKgel Super HZ2000 (manufactured by Tosoh Corporation) connected in series. As the result, the weight average molecular weight was 25,000 on polystyrene conversion. When the acid value of the polymer was calculated using the method disclosed in Japanese Industrial Standard (JIS K 0070:1992), the acid value was 99 mg KOH/g.

(Preparation of Cyan Dispersion Liquid C1)

Next, 5.0 g of the above-described polymeric dispersing agent 1 solution converted to solid content, 10.0 g of cyan pigment Pigment Blue 15:3 (manufactured by Dainichiseika Color and Chemicals Mfg. Co., Ltd.), 40.0 g of methyl ethyl ketone, 8.0 g of 1 mol/L (liter; same applies below) sodium hydroxide solution, and 82.0 g of ion exchange water, along with 300 g of 0.1 mm zirconia beads were supplied to a vessel, and dispersed at 1000 rpm for 6 hours using a ready mill disperser (manufactured by Aimex Co., Ltd.). The obtained dispersion liquid was subjected to reduced pressure condensation with an evaporator until the methyl ethyl ketone could be sufficiently distilled away, then further condensed until a pigment density of 10% by mass and a water content of 85% by mass were reached, whereby a cyan dispersion C1 was prepared.

A volume average particle diameter (secondary particle) of the obtained cyan dispersion liquid C1 was 77 nm when measured using a dynamic light scattering method with a Microtrac particle size distribution measurement apparatus (Version 10.1.2-211BH (trade name) manufactured by Nikkiso, Co., Ltd.).

(Synthesis of Self-Dispersing Resin Particles 1)

To a 2 L three-necked flask provided with an stirrer, a thermometer, a reflux condensor and a nitrogen gas introducing tube, 360.0 g of methyl ethyl ketone was added, followed by heating up to 75° C. Thereafter, maintaining the temperature inside the flask at 75° C., a mixed solution consisting of 180.0 g of phenoxyethyl acrylate, 162.0 g of methyl methacrylate, 18.0 g of acrylic acid, 72 g of methyl ethyl ketone and 1.44 g of “V-601” (trade name, manufactured by Wako Pure Chemical Industries, Ltd.) was added dropwise thereto at a constant speed so that the dropwise addition was completed in two hours. After the completion of the dropwise addition, a solution containing 0.72 g of “V-601” and 36.0 g of methyl ethyl ketone was added thereto, followed by stirring at 75° C. for 2 hours, further followed by adding a solution consisting of 0.72 g of “V-601” and 36.0 g of isopropanol and stirring at 75° C. for 2 hours. Thereafter, heating was performed to 85° C. and stirring was further continued for 2 hours, whereby a phenoxyethyl acrylate/methyl methacrylate/acrylic acid copolymer resin solution (50/45/5 [mass ratio]) was obtained.

The weight average molecular weight (Mw) of the obtained copolymer was 64,000 and the acid value was 38.9 mg KOH/g. Here, the weight average molecular weight and the acid value were measured using the same method as for the weight average molecular weight and the acid value of the above-described polymeric dispersing agent 1.

Next, 668.3 g of the obtained resin solution was weighed, 388.3 g of isopropanol and 145.7 ml of 1 mol/L NaOH aqueous solution were added thereto and the temperature inside the reaction vessel was raised to 80° C. Then, after 720.1 g of distilled water was added dropwise at a speed of 20 ml/min to perform water dispersion, the temperature inside the reaction vessel was kept at 80° C. for 2 hours under atmospheric pressure, at 85° C. for 2 hours and at 90° C. for 2 hours, subsequently, the inside of the reaction vessel was depressurized to distil away a total of 913.7 g of isopropanol, methyl ethyl ketone and distilled water, whereby an aqueous dispersion of self-dispersing resin particles 1 having a solid content concentration of 28.0% by mass and water content of 72.0% by mass was obtained.

(Preparation of Cyan Ink C1)

Components having the following composition were mixed and the obtained mixture was filtered through a filter with a hole diameter of 5 μm to remove coarse particles from the mixture, whereby a cyan ink C1 was obtained.

The water content with respect to the total amount of the cyan ink C1 is 74.5% by mass.

—Composition of the Cyan Ink C1—

Above-described obtained cyan dispersion C1 30% by mass

Below-described polymerizable compound 1 (polymerizable compound) 10% by mass

Hydroxyethyl acrylamide (polymerizable compound) 5% by mass

Aqueous dispersion of above-described obtained self-dispersing resin particles 1

7.1% by mass

Olfine E1010 (manufactured by Nissin Chemical Industry Co., Ltd.) 1% by mass

Irgacure-2959 (manufactured by BASF Japan Co., Ltd.) 3% by mass

Ion exchangewater 43.9% by mass

Here, the polymerizable compound 1 is the following compound. The polymerizable compound 1 is a water-soluble polymerizable compound represented by the general formula (1).

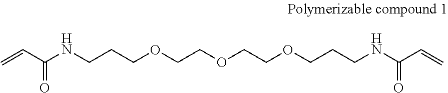

The polymerizable compound 1 was synthesized as follows.

First, 40.0 g of 4,7,10-trioxa-1,13-tridecanediamine (182 mmol), 37.8 g of sodium hydrogen carbonate (450 mmol), 100 g of water, and 300 g of tetrahydrofuran were added to a 1 L three-necked flask provided with an stirrer and 35.2 g of acrylic acid chloride (389 mmol) was added dropwise thereto over 20 minutes under an ice bath. After completion of the dropwise addition, the solution was stirred at room temperature for 5 hours, and tetrahydrofuran was then removed from the obtained reaction mixture under reduced pressure. Subsequently, an aqueous layer was extracted four times with 200 ml of ethyl acetate, and the resultant organic layer was dried using magnesium sulfate, followed by filtration and solvent distillation under reduced pressure, thereby obtaining 35.0 g (107 mmol, yield: 59%) of a solid of the desired polymerizable compound 1.

Here, the polymerizable compound 2 to be described later also can be synthesized by a method similar to the polymerizable compound 1.

<Preparation of Cyan Inks C2 to C12>

Cyan inks C2 to C12 were prepared in the same manner as the preparation of the cyan ink C1 except that the polymerizable compound 1 used as the polymerizable compound and the hydroxyethyl acrylamide in the preparation of the above-described cyan ink C1 were changed as shown in the following Table 1.

As shown in Table 1, only one polymerizable compound was used in the cyan inks C5 and C11, and two polymerizable compounds were used in the cyan inks C1 to C4, C6 to C10, and C12.

Here, the polymerizable compounds 2 and 3 are the following compounds. The polymerizable compound 2 is a water-soluble polymerizable compound represented by the general formula (1).

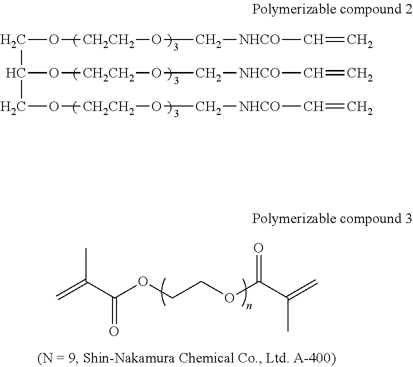

### <Preparation of Magenta Inks M1 to M12>

Magenta inks M1 to M12 were respectively prepared in the same manner as the preparation of the cyan inks C1 to C12 except that the cyan pigment Pigment Blue 15:3 was respectively changed to the same amount of magenta pigment Pigment Red 122 (manufactured by Dainichiseika Color & Chemicals Mfg. Co., Ltd.) in the preparation of the above-described cyan inks C1 to C12

<Preparation of Yellow Inks Y1 to Y12>

Yellow inks Y1 to Y12 were respectively prepared in the same manner as the preparation of the cyan inks C1 to C12 except that the cyan pigment Pigment Blue 15:3 was respectively changed to the same amount of yellow pigment Pigment Yellow 74 (manufactured by Dainichiseika Color & Chemicals Mfg. Co., Ltd.) in the preparation of the above-described cyan inks C1 to C12.

<Preparation of Black Inks K1 to K12>

Black inks K1 to K12 were respectively prepared in the same manner as the preparation of the cyan inks C1 to C12 except that the cyan pigment Pigment Blue 15:3 was respectively changed to the same amount of carbon black (MA-1, manufactured by Mitsubishi Kasei Corporation) in the preparation of the above-described cyan inks C1 to C12.

<<Preparation of Aqueous Processing Liquid>>

(Preparation of Processing Liquid 1)

Components having the following composition were mixed and the processing liquid 1 was prepared.

The viscosity, surface tension, and pH (25° C.) of the processing liquid 1 were a viscosity of 2.5 mPa·s, a surface tension of 40 mN/m, and a pH of 1.0. The surface tension was measured using a fully automatic surface tensiometer CBVP-Z manufactured by Kyowa Interface Science Co., Ltd., and the viscosity was measured using a DV-III Ultra CP manufactured by Brookfield Engineering Inc. The pH was measured using a pH meter HM-30R manufactured by DKK-Toa Corporation.

—Composition of Processing Liquid 1—

| | |
|---|---|
| Malonic acid (manufactured by Wako Pure Chemical | 25% by mass |
| Industries Ltd.) | |
| Diethylene glycol monomethyl ether (manufactured by | 20.0% by mass |
| Wako Pure Chemical Industries Ltd.) | |
| EMULGEN P109 (trade name, manufactured by Kao | 1.0% by mass |
| Corporation, nonionic surfactant) | |
| Ion exchange water | 54% by mass |

(Preparation of Processing Liquid 2)

Components having the following composition were mixed and the processing liquid 2 was prepared. The viscosity, surface tension, and pH (25° C.) of the processing liquid 2 were a viscosity of 2.5 mPa·s, a surface tension of 40 mN/m, and a pH of 1.0. Here, the viscosity, surface tension, and pH (25° C.) were measured using the same method as the viscosity, surface tension, and pH (25° C.) of processing liquid 1.

—Composition of Processing Liquid 2—

| | |
|---|---|
| Magnesium nitrate (manufactured by Wako Pure | 5.0% by mass |
| Chemical Industries Co., Ltd.) | |
| Diethylene glycol (manufactured by Wako Pure | 10.0% by mass |
| Chemical Industries Co., Ltd.) | |
| Methyl alcohol (manufactured by Wako Pure Chemical | 5.0% by mass |
| Industries Co., Ltd.) | |
| EMULGEN P109 (manufactured by Kao | 0.6% by mass |
| Corporation, nonionic surfactant) | |
| Irgacure-2959 (manufactured by BASF Japan Co., | 2.0% by mass. |
| Ltd.) | |
| Ion exchange water | 77.4% by mass |

### Examples 1 to 12

### Image Recording and Evaluation

Using the above-described aqueous ink and processing liquid, an image was recorded in the following manner and evaluation of the following was performed with respect to the recorded image. The evaluation results are shown in Table 1 below.

<Image Recording>

First, an ink jet recording apparatus having the same configuration as the ink jet recording apparatus 100 shown in FIG. 1 was prepared.

Here, the configuration of the processing liquid drying zone 13 is configured such that an air blower performing drying by blowing drying air is provided in the recording surface side of the recording medium and an infrared heater is provided in the non-recording surface side of the recording medium, whereby it is possible to evaporate (dry) 70% by mass or more of the water in the processing liquid by adjusting the temperature and the air amount until 900 msec has passed since the starting of the adding of the processing liquid by the processing liquid adding unit.

In addition, in the ink ejection unit 30, a black ink ejection head 30K, a magenta ink ejection head 30M, a cyan ink ejection head 30C, and a yellow ink ejection head 30Y are arranged in order along the transport direction (in the direction of the arrow of the dot-dashed line in FIG. 1). Each head is a full line head having 1200 dpi/10 inch width (drive frequency: 25 kHz, transport speed at the time of drawing of the recording medium 530 mm/sec) and it is possible to eject each color in the main scanning direction with a single pass and to perform recording.

The configuration of the ultraviolet ray irradiation zone 16 is such that UV (ultraviolet rays) is irradiated with respect to the image by a metal halide lamp M008-L41 manufactured by Eye Graphics Co., Ltd. under conditions where the total irradiation amount at the image surface becomes 1.0 J/cm².

When recording the image, the processing liquid 1, and any one of black inks K1 to K12, any one of magenta inks M1 to M12, any one of cyan inks C1 to C12, and any one of yellow inks Y1 to Y12 are respectively charged into a storage tank (not shown) respectively linked to the processing liquid ejection head 12S and each color ink ejection head 30K, 30M, 30C, and 30Y.

During recording of the image, the processing liquid and each color of the inks are ejected with a resolution of 1200 dpi×600 dpi with ink droplets of 2.5 μl. At this time, the solid image is set by ejecting ink onto the entire surface of a sample in which the recording medium is cut to A5 size.

Further, as the recording medium, “U-LITE” manufactured by Nippon Paper Industries Co., Ltd. (basis weight 84.9 g/m²) was used.

Further, the addition amount of the processing liquid onto the recording medium was adjusted so as to be 5 ml/m².

Using the ink jet recording apparatus adjusted as above, image recording was carried out in the following manner.

First, processing liquid was ejected from the processing liquid ejection head 12S onto the recording medium with a single pass (ejection amount 5 ml/m²), followed by drying the processing liquid ejected onto the recording medium in the processing liquid drying zone 13. At this time, the recording medium was set to pass through the processing liquid drying zone 13 before 900 msec passed from the ejection start of the processing liquid. In the processing liquid drying zone 13, while heating the temperature of the processing liquid landing surface to 40 to 45° C. with an infrared heater from the reverse side (rear side) of the processing liquid landing surface, warm air of 120° C. was sent to the processing liquid landing surface by an air blower, the air amount was changed so as to adjust to a predetermined drying amount, and the processing liquid was dried.

Subsequently, cyan ink from the cyan ink ejection head 30C was ejected on the processing liquid dried as described above with a single pass with a halftone dot rate of 100% as first color ink (“ink 1” in Table 1), yellow ink from the yellow ink ejection head 30Y was ejected on the ejected cyan ink with a single pass with a halftone dot rate of 4% as second color ink (“ink 2” in Table 1), and a two-color image (green solid image) was recorded. At this time, the time from ejection completion of the cyan ink until the yellow ink ejection start was adjusted so as to become 140 msec.

Thereafter, while heating with an infrared heater from the reverse side (rear side) of the ink landing surface, warm air of 120° C. and 5 m/sec was sent by an air blower to the recording surface for 15 seconds, and the two-color image was dried.

With respect to the two-color image after drying, in the ultraviolet ray irradiation zone 16, UV light (metal halide lamp M008-L41 manufactured by Eye Graphics Co., Ltd.) was irradiated such that the total irradiation amount became 1.0 J/cm², and the two-color image was cured.

<<Image Evaluation>>

<Color Reproduction>

The chromaticity (a*, b*) of the above-described two-color image (green solid image) after curing was measured using a scanning spectrometer manufactured by Gretag Macbeth Co., Ltd. a* and b* both indicate that the color reproduction range is wider as the absolute value is greater.

The evaluation results are shown in Table 1 below.

<Glossiness>

60° glossiness (°) of the above-described two-color image (green solid image) after curing was measured using a HORIBA GLOSS CHECKER IG-331 (manufactured by Horiba, Ltd.). The evaluation results are shown in Table 1 below.

TABLE 1

| | | | | | | | Processing | Evaluation results | | |
|---|---|---|---|---|---|---|---|---|---|---|
| | Ink 1 | | | | | Ink 2 | liquid | | Glossi- | |
| | Ink | Polymerizable compound | | | | Ink | Processing | Chromaticity | ness | |
| | No. | Type | Amount | Type | Amount | No. | liquid No. | (a*, b*) | (°) | Notes |
| Example 1 | C1 | Polymerizable compound 1 | 10% | Hydroxyethyl | 5% | Y1 | 1 | (−65, 17) | 41 | Comparative |
| | | (bifunctional acrylamide) | | acrylamide | | | | | | Example |
| Example 2 | C2 | Polymerizable compound 1 | 10% | Acryloyl morpholine | 5% | Y2 | 1 | (−63, 15.5) | 37 | Comparative |
| | | (bifunctional acrylamide) | | | | | | | | Example |
| Example 3 | C3 | Polymerizable compound 1 | 10% | N-Vinyl-ε-caprolactam | 5% | Y3 | 1 | (−71, 19) | 62 | Present |
| | | (bifunctional acrylamide) | | | | | | | | Invention |
| Example 4 | C4 | Polymerizable compound 1 | 10% | N-Vinyl pyrrolidone | 5% | Y4 | 1 | (−70, 20) | 61.5 | Present |
| | | (bifunctional acrylamide) | | | | | | | | Invention |
| Example 5 | C5 | Polymerizable compound 1 | 15% | — | — | Y5 | 1 | (−66, 18) | 42 | Comparative |
| | | (bifunctional acrylamide) | | | | | | | | Example |
| Example 6 | C6 | Polymerizable compound 2 | 10% | N-Vinyl pyrrolidone | 5% | Y6 | 1 | (−72, 18.7) | 61.8 | Present |
| | | (trifunctional acrylamide) | | | | | | | | Invention |
| Example 7 | C7 | Polymerizable compound 3 | 10% | Hydroxyethyl | 5% | Y7 | 1 | (−62, 16) | 37 | Comparative |
| | | (bifunctional acryl ester) | | acrylamide | | | | | | Example |
| Example 8 | C8 | Polymerizable compound 3 | 10% | Acryloyl morpholine | 5% | Y8 | 1 | (−63, 17) | 35 | Comparative |
| | | (bifunctional acryl ester) | | | | | | | | Example |
| Example 9 | C9 | Polymerizable compound 3 | 10% | N-Vinyl-ε-caprolactam | 5% | Y9 | 1 | (−66, 19) | 36 | Comparative |
| | | (bifunctional acryl ester) | | | | | | | | Example |
| Example 10 | C10 | Polymerizable compound 3 | 10% | N-Vinyl pyrrolidone | 5% | Y10 | 1 | (−67, 18) | 37 | Comparative |
| | | (bifunctional acryl ester) | | | | | | | | Example |
| Example 11 | C11 | N-vinyl pyrrolidone | 15% | — | — | Y11 | 1 | (−67, 17) | 37 | Comparative |
| | | | | | | | | | | Example |
| Example 12 | C12 | Hydroxyethyl acrylamide | 10% | N-Vinyl pyrrolidone | 5% | Y12 | 1 | (−63, 17) | 35 | Comparative |
| | | | | | | | | | | Example |

In Table 1, the “Amount” of the polymerizable compound represents the content (% by mass) of the polymerizable compound with respect to the total mass in the ink composition.

As shown in Table 1, in Examples 3, 4, and 6 using inks including water-soluble polymerizable compounds (polymerizable compounds 1 and 2) represented by general formula (1) and N-vinyl lactam compounds (N-vinyl pyrrolidone, N-vinyl-ε-caprolactam), in comparison with each of the Comparative Examples, the color reproduction range was wider and the glossiness of the image was higher.

Next, image forming and evaluation was performed in the same manner as for Examples 1 to 12 except that the processing liquid 1 was changed to the processing liquid 2 and it was confirmed that, in the same manner as the results of Examples 1 to 12, by using an ink including water-soluble polymerizable compounds (polymerizable compounds 1 and 2) represented by general formula (1) and N-vinyl lactam compounds (N-vinyl pyrrolidone, N-vinyl-ε-caprolactam), an image with a wide color reproduction range and high glossiness may be obtained.

Further, in the Examples 1 to 12 as described above, a case has been shown in which a green solid image was formed using cyan inks C1 to C12 as ink 1 and using yellow inks Y1 to Y12 as ink 2; however, also in a case where a red solid image is formed using magenta inks M1 to M12 as ink 1 and using yellow inks Y1 to Y12 as ink 2 or a case where a blue solid image is formed using cyan inks C1 to C12 as ink 1 and using magenta inks M1 to M12 as ink 2, in the same manner as the results of Examples 1 to 12, when using an ink composition including water-soluble polymerizable compounds (polymerizable compounds 1 and 2) represented by general formula (1) and N-vinyl lactam compounds (N-vinyl pyrrolidone, N-vinyl-ε-caprolactam), an image with a wide color reproduction range and high glossiness may be obtained.

This application claims priority under 35 U.S.C. §119 of Japanese Patent application JP 2011-183094, filed on Aug. 24, 2011, the entire contents of which are hereby incorporated by reference.

What is claimed is:

1. An ink composition comprising:
a pigment;
a water-soluble polymerizable compound represented by general formula (1);
an N-vinyl lactam compound;
a polymerization initiator; and
water. 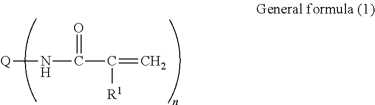
[In the general formula (1), Q represents an n-valent linking group, and R¹ represents a hydrogen atom or a methyl group. Further, n represents an integer of 2 or more.]

2. The ink composition according to claim 1, wherein the N-vinyl lactam compound is a monofunctional N-vinyl lactam compound.

3. The ink composition according to claim 2, wherein the N-vinyl lactam compound is a compound represented by general formula (A) below. 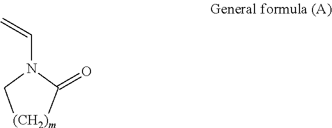
[In general formula (A), m represents an integer of 1 to 5.]

4. The ink composition according to claim 1, wherein Q in the general formula (1) is a linking group including an oxyalkylene group.

5. The ink composition according to claim 2, wherein Q in the general formula (1) is a linking group including an oxyalkylene group.

6. The ink composition according to claim 3, wherein Q in the general formula (1) is a linking group including an oxyalkylene group.

7. The ink composition according to claim 3, wherein the N-vinyl lactam compound is at least any one of N-vinyl pyrrolidone and N-vinyl-ε-caprolactam.

8. The ink composition according to claim 4, wherein the N-vinyl lactam compound is at least any one of N-vinyl pyrrolidone and N-vinyl-ε-caprolactam.

9. The ink composition according to claim 1, wherein the water content with respect to the total amount of the ink composition is 50% by mass or more.

10. The ink composition according to claim 1, wherein n in the general formula (1) is an integer of 3 or more.

11. An ink set comprising:
the ink composition according to claim 1; and
a processing liquid including a flocculant causing the components in the ink composition to aggregate.

12. An image forming method using the ink set according to claim 11, comprising:
a processing liquid adding step of adding the processing liquid onto a recording medium;
an ink adding step of adding the ink composition onto the processing liquid added onto the recording medium; and
an active energy ray irradiating step of irradiating active energy rays to the ink composition added onto the recording medium.

13. An image forming method using an ink set including a first ink composition according to claim 1; a second ink composition containing a pigment, a polymerizable compound, a polymerization initiator, and water; and a processing liquid including a flocculant causing at least the components in the first ink composition to aggregate, comprising:
a processing liquid adding step of adding the processing liquid onto a recording medium;
a first ink adding step of adding the first ink composition onto the processing liquid added onto the recording medium;
a second ink adding step of adding the second ink composition onto the first ink composition added onto the recording medium; and
an active energy ray irradiating step of irradiating active energy rays to the ink composition of a plurality of colors including the first ink composition and the second ink composition added onto the recording medium.

14. The image forming method according to claim 13, wherein the flocculant further causes the components in the second ink composition to aggregate.

15. The image forming method according to claim 12, wherein the recording medium is coated paper having a base sheet and a coating layer including an inorganic pigment.

16. The image forming method according to claim 13, wherein the recording medium is coated paper having a base sheet and a coating layer including an inorganic pigment.
